(19) United States
(12) Patent Application Publication
(10) Pub. No.: US 2010/0019126 A1
(43) Pub. Date: Jan. 28, 2010

(54) OPTICAL HEAD DEVICE, OPTICAL INFORMATION RECORDING/REPRODUCING DEVICE, AND OPTICAL INFORMATION RECORDING/REPRODUCING METHOD THEREOF

(76) Inventor: Ryuichi Katayama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/450,019

(22) PCT Filed: Feb. 13, 2008
(86) PCT No.: PCT/JP2008/052367

§ 371 Date: Sep. 8, 2009

(30) Foreign Application Priority Data
Mar. 13, 2007 (JP) 2007-062902

(51) Int. Cl. G01J 1/32

(52) U.S. Cl. 250/205

(57) ABSTRACT

Between a semiconductor laser and a polarization beam splitter, a polarization direction control element, including a liquid crystal polymer layer divide into a plurality of concentric circle regions having different optical axis directions, is provided. A voltage is applied to the liquid crystal polymer layer at the time of recording. Since the polarization direction control element acts as a full wavelength plate for incident light, the light exiting the polarization beam splitter has an intensity distribution identical to that of the incident light and the rim strength in objective lens lowers. No voltage is applied to the liquid crystal polymer layer at the time of reproduction. Since the polarization direction control element operates as a half wavelength plate for rotating the polarization direction of the incident light more toward the central portion, the light exiting the polarization beam splitter has an intensity becoming lower toward the central portion as compared with the incident light, and the rim strength in an objective lens increases.

### TECHNICAL FIELD

The present invention relates to an optical head device recoding and reproducing information on an optical recording medium, an optical information recoding/reproducing device, and an optical information recoding/reproducing method thereof. This application claims the priority based on Japanese Patent Application No. 2007-62902, and the disclosure of Japanese Patent Application No. 2007-62902 is incorporated herein by reference.

### BACKGROUND ART

A recording density in an optical information recording/reproducing device is in inverse proportion to a square of a diameter of a condensed spot formed on an optical recording medium by an optical head device. That is, the smaller the diameter of the condensed spot is, the larger the recording density becomes. Meanwhile, when light passes from a light source in the optical head device to the optical recording medium, a ratio of intensity of a light passing through a rim of an objective lens to intensity of a light passing through a center of the objective lens is called rim intensity. The larger the rim intensity is, the smaller the diameter of the condensed spot becomes, however, efficiency of an optical system in an outward path is decreased. That is, there is a trade-off relationship between the diameter of the condensed spot and the efficiency of the optical system in the outward path.

In a case of recording information on the optical recording medium, only a region with a strong intensity at a central portion of the condensed spot contributes to form a recording mark. Accordingly, even when the diameter of the condensed spot is slightly large, a recording mark smaller than the diameter of the condensed spot can be formed, and quality of the formed recording mark does not deteriorate so much. That is, the diameter of the condensed spot can be slightly large. On the other hand, since light is required to be irradiated on the optical recording medium with high power, the efficiency of the optical system in the outward path is desired to be as high as possible. Meanwhile, in a case of reproducing information from the optical recording medium, whole of the condensed spot contributes to reproduce a signal. For this reason, when the diameter of the condensed spot is large, signals from other recording marks arranged around the recording mark to be reproduced interfere with a signal from the recording mark to be reproduced, and the quality of the reproduced signal is deteriorated. That is, the diameter of the condensed spot is desired to be as small as possible. On the other hand, since light can be irradiated on the optical recording medium with low power, the efficiency of the optical system in the outward path can be slightly low.

As described above, in order to eliminate the trade-off relationship between the diameter of the condensed spot and the efficiency of the optical system in the outward path and improve the recording density in the optical information recording/reproducing device, it is effective to increase the efficiency of the outward path in the optical system at the time of recording and to reduce the diameter of the condensed spot as much as possible at the time of reproducing. For this purpose, it is preferable that the optical head device has a function for switching the rim intensity in the objective lens between the recording and the reproducing. Specifically, it is preferable that the efficiency of the optical system is increased as much as possible by reducing the rim intensity to slightly increase the diameter of the condensed spot in the case of recording, and the efficiency of the optical system is slightly reduced by reducing the rim intensity to reduce the diameter of the condensed spot as much as possible in the case of reproducing.

For example, in Japanese Laid-Open Patent Application (JP-P2006-107650), an optical head device having a function for switching rim intensity in an objective lens between the recording and the reproducing is disclosed. FIG. 1 shows a main portion of the optical head device. A part of outputted light from a semiconductor laser which is installed in a module 29 transmits through a diffractive optical element provided at a window part of the module 29, is adjusted to be parallel light with a collimator lens 30, passes through a polarization direction switching element 31 and a polarization lens 32, is converted from linear polarized light to circular polarized light by a quarter wavelength plate 33, and is collected on a disk 35 by an objective lens 34. Reflection light from the disk 35 passes through the objective lens 34 in an opposite direction, is converted by the quarter wavelength plate 33 from circular polarized light to linear polarized light whose polarization direction is perpendicular to a light in the outward path, passes through the polarization lens 32, the polarization direction switching element 31, and the collimator lens 30 in an opposite direction, is partially diffracted by the diffractive optical element provided at the window part of the module 29, and is received by a light detector provided in the module 29. The polarization direction switching element 31 switches an operation between an operation for acting as a full wavelength plate which does not change a polarization direction of incoming light and an operation for acting as a half wavelength plate which changes the polarization direction of the incoming light by 90°.

FIGS. 2A and 2B are cross sectional views showing the polarization lens 32. The polarization lens 32 has a configuration, in which a liquid crystal polymer layer 37a and a filling material 38a are sandwiched between a glass substrate 36a and a glass substrate 36b, and a liquid crystal polymer layer 37b and a filling material 38b are sandwiched between a glass substrate 36b and a glass substrate 36c. At a boundary between the liquid crystal polymer layer 37a and the filling material 38a, a lens is formed so that the liquid crystal polymer layer 37a becomes a concave shape and the filling material 38a becomes a convex shape. At a boundary between the liquid crystal polymer layer 37b and the filling material 38b, a lens is formed so that the liquid crystal polymer layer 37b becomes a convex shape and the filling material 38b becomes a concave shape. The liquid crystal polymer layers 37a and 37b have a uniaxial refractive index anisotropy, and a refractive index with an extraordinary light component is larger than that with an ordinary light component. Meanwhile, refractive indexes of the filling materials 38a and 38b are equal to the refractive indexes of the liquid crystal polymer layers 37a and 37b with an ordinary light component.

At the time of recording, the polarization direction switching element 31 does not change a polarization direction of incoming light. At this time, as shown in FIG. 2A, light in the outward path, which is inputted to the polarization lens 32 as parallel light, becomes linear polarized light whose polarization direction is perpendicular to the paper surface, and becomes ordinary light with the liquid crystal polymer layers 37a and 37b. Accordingly, the boundary between the liquid crystal polymer layer 37a and the filling material 38a and the boundary between the liquid crystal polymer layer 37b and the filling material 38b do not act as lenses for the light in the outward path. As the result, the light in the outward path does not change a beam diameter in the polarization lens 32 and is outputted from the polarization lens 32 as parallel light. Accordingly, the rim intensity in the objective lens 34 becomes low. On the other hand, at the time of reproducing, the polarization direction switching element 31 changes the polarization direction of the incoming light by 90°. At this time, as shown in FIG. 2B, the light in the outward path, which is inputted to the polarization lens 32 as parallel light, becomes the linear polarized light whose polarization direction is parallel with the paper surface and becomes extraordinary light for the liquid crystal polymer layers 37a and 37b. Accordingly, the boundary between the liquid crystal polymer layer 37a and the filling material 38a acts as a concave lens with the light in the outward path, and the boundary between the liquid crystal polymer layer 37b and the filling material 38b acts as a convex lens with the light in the outward path. As the result, the light in the outward path is increased in the beam diameter by the polarization lens 32, and is outputted from the polarization lens 32 as parallel light. Accordingly, the rim intensity in the objective lens 34 becomes large. In this manner, the optical head device in FIG. 1 changes the beam diameter of the light in the outward path by using a lens function for switching the rim intensity in the objective lens. As a related example of the optical head device having such function, an optical head device is described in National publication of translated version of PCT Application JP-P 2006-500710.

In order to increase the beam diameter of the light in the outward path in the polarization lens 32 when the optical head device shown in FIG. 1 reproduces information from the disk 35, in the polarization lens 32, it is required to increase a distance from a lens formed at the boundary between the liquid crystal polymer layer 37a and the filling material 38a to a lens formed at the boundary between the liquid crystal polymer layer 37b and the filling material 38b. That is, since this optical head device is required to increase a thickness of the polarization lens 32, it is difficult to reduce the size of the optical head device. In addition, if the polarization lens 32 inclines to an optical axis of the light in the outward path inputted to the polarization lens 32 at a time of reproducing, an optical axis of the lens formed in the boundary between the liquid crystal polymer layer 37a and the filling material 38a and an optical axis of the lens formed in the boundary between the liquid crystal polymer layer 37b and the filling material 38b incline to the optical axis of the light. For this reason, an aberration is generated in the light of the outward path outputted from the polarization lens 32, thereby a shape of the condensed spot formed on the disk 35 is distorted. That is, since this optical head device is required to adjust the inclination of the polarization lens 32 with high precision, it is difficult to reduce a cost for the optical head device. The same can be applied to the optical head device described in National publication of translated version of PCT Application JP-P 2006-500710.

In addition, as another example of the related optical head device having a function for switching rim intensity in an objective lens, an optical head device is described in Japanese Laid-Open Patent Application (JP-A-Heisei 11-316965). In this optical head device, a liquid crystal optical element is provided in a light path of the light in the outward path. The liquid crystal optical element includes a patterned electrode which is divided into a circular region around an optical axis of incoming light and a plurality of annular regions. In a case where a voltage is not applied to the respective regions of the patterned electrode in the liquid crystal optical element, a transmittance of the liquid crystal optical element with a light passing through the respective regions is approximately 100%. Accordingly, an intensity distribution of the light in the outward path is not changed by transmitting through the liquid crystal optical element. Meanwhile, in a case where the voltage is applied to the respective regions of the pattern electrode in the liquid crystal optical element, the transmittance of the liquid crystal element with the light passing through the respective regions depends on the applied voltage. When a voltage is applied to a region close to the optical axis of the incoming light so that the transmittance is reduced, and a voltage is applied to a region far from the optical axis of the incoming light so that the transmittance is increased, the intensity distribution of the light in the outward path is changed by transmitting through the liquid crystal optical element so that light intensity at a peripheral portion is relatively higher than that of a central portion in a cross-section perpendicular to the optical axis. That is, the rim intensity of the light in the outward path in the objective lens can be increased by applying an appropriate voltage to the respective regions of the patterned electrode in the liquid crystal optical element.

In such optical head device using the liquid crystal optical element which changes the transmittance based on the voltage applied to the pattern electrode, different voltages are applied to the respective regions of the patterned electrode in the liquid crystal optical element, and phases of the light transmitting through the respective regions in the liquid crystal optical element are different from each other. In such optical head device, a wave aberration is generated in the light transmitting through the liquid crystal optical element, a shape of the condensed spot formed on the optical recording medium is distorted, and thereby quality of a reproduced signal is deteriorated.

In Japanese Laid-Open Patent Application (JP-P2001-134972), a semiconductor laser module is described, in which a semiconductor laser light source and a multi-fractionation light detector for detecting a predetermined information signal by receiving a laser light which is outputted from a semiconductor laser light source and reflected by an optical information recording medium are arranged in one box. In the semiconductor laser module, a linear diffractive grating or a holographic diffractive grating having a function for introducing the laser light reflected by the optical information recording medium into the multi-fractionation light detector is formed on a transparent member, and the transparent member is provided at a window part of the box. In these diffractive gratings, in a laser beam outputted from the semiconductor laser light source and passing through the diffractive gratings, a width or depth of a grating groove in a region where a beam in a vicinity of a central portion passes is different from a width or depth of a grating groove in a region where a light in the vicinity of an outer rim portion passes.

In Japanese Laid-Open Patent Application (JP-P2004-87098), an optical element is disclosed, which has a central axis line, a first and a second curved surfaces extending along a direction lateral to the central axis line, and a circumferential surface extending between the first curved surface and the second curved surface. A light intensity distribution of the outputted light outputted from the second curved surface and a light intensity distribution of the incoming light incoming to the first surface are different from each other due to refraction of the light inputted to the first curved surface and outputted from the second curved surface. In this optical element, a rim intensity improvement rate R is 1.07 or more and is 1.5 or less, the rim intensity improvement rate R is represented by a rate of rim intensity of the outputted light to the rim intensity of the incoming light, and the rim intensity is represented by a rate of an intensity in a peripheral part to an intensity in a central part.

In Japanese Laid-Open Patent Application (JP-A-Heisei 5-314572), an optical pick-up device is disclosed, which includes an optical magnetic recording medium having a guide groove, a light source for outputting laser light that is linear polarized light, a light detector, and a light path formation part. The light detector receives a reflection light from the above-mentioned optical magnetic recording medium and extracts various types of signals. The light path formation part leads the outputted light from the light source to the optical magnetic recording medium, and leads the reflected light from the optical magnetic recording medium to the light detector. The light path formation part includes a means configured to lead the outputted light outputted from the light source to the optical magnetic recording medium so that a transmission characteristic becomes high at a position of the optical axis and becomes low at a peripheral portion, and a means adapted to lead the reflected light from the optical magnetic recording medium to the light detector so that a transmission characteristic becomes low at the position of the optical axis and becomes high at the peripheral portion.

In Japanese Patent 2655747, an optical pickup is disclosed, which reads information from an optical disk, by collecting a light beam from a light source whose cross sectional intensity distribution is the Gaussian distribution type with an objective lens, irradiating the light beam as a light spot on the optical disk, and receiving reflected light from the optical disk with a light-receiving element. In this optical pickup, a diffractive element having a diffractive grating smaller than a diameter of the light beam from the light source is provided between the light source and the objective lens so that the reflected light from the optical disk is diffracted and led to the light-receiving element.

### DISCLOSURE OF INVENTION

An object of the present invention is to provide an optical head device, an optical information recording/reproducing device, and an optical information recording/reproducing method thereof, which enable to reduce a size and a cost with a good performance.

In an aspect of the present invention, an optical head device includes an objective lens, a light detector, a light separation part, and an intensity distribution switching part. The objective lens collects outward path light outputted from a light source on an optical recording medium. The light detector receives return path light which is collected by the objective lens and is reflected by the optical recording medium. The light separation part splits the outward path light and the return path light. The intensity distribution switching part is provided in a light path of the outward path light, changes intensity of the outputted light with the incoming light based on a position in a cross-section perpendicular to an optical axis of the outward path light, and is able to switch an intensity distribution of the outward path light without changing a phase distribution of the outward path light.

An optical information recording/reproducing device according to the present invention includes the above-mentioned optical head device, and a driving circuit for driving the intensity distribution switching part provided in the above-mentioned optical head device to switch the intensity distribution.

In another aspect of the present invention, an optical information recording/reproducing method includes a light-collection step, a light detection step, a light separation step, and an intensity distribution switching step. At the light-collection step, an objective lens collects an outward path light outputted from a light source on an optical recording medium. The light detection step includes a step for receiving a return path light that is collected by the objective lens and is reflected by the optical recording medium. At the light separation step, the outward path light and the return path light are split. At the intensity distribution switching step, an intensity of the outputted light with the incoming light is changed based on a position in a cross section perpendicular to an optical axis of the outward path light without changing a phase distribution of the outward path light, and the intensity distribution of the outward path light is switched.

In the present invention, in the optical head device, the optical information recording/reproducing device, and the optical information recording/reproducing method thereof, the intensity distribution switching part for switching the intensity distribution of the light in the outward path is provided in the outward path so that the rim intensity of the objective lens is switched between the recording and the reproducing. The intensity distribution switching part switches the intensity distribution of the outward path light between the recording and the reproducing, by changing the intensity of the outputted light with the incoming light based on a position in a cross-section perpendicular to the optical axis. This does not switch the intensity distribution by adding a lens function for changing a beam diameter of the outward path light. Since the intensity distribution switching part does not have the lens function, a thickness of the intensity distribution switching part is not required to be increased, and a size of the optical head device can be decreased. In addition, since the intensity distribution switching part does not have the lens function, inclination of the intensity distribution switching part is not required to be precisely adjusted, and a cost of the optical head device can be decreased. Moreover, the intensity distribution switching part does not change a phase of the outputted light with the incoming light based on a position in the cross-section perpendicular to the optical axis. Accordingly, a wavefront aberration is not generated in the outputted light from the intensity distribution switching part, and a performance of the optical head device can be improved.

According to the present invention, an optical head device, an optical information recording/reproducing device, and an optical information recording/reproducing method thereof are provided, which enable to reduce a size and cost of the optical head device and to improve a performance. That is, according to the present invention, since the intensity distribution switching part for switching the intensity distribution of the light in the outward path does not have a lens function, the thickness of the intensity distribution switching part is not required to be increased, the inclination of the intensity distribution switching part is not required to be precisely adjusted, and the size and cost of the optical head device can be reduced. In addition, according to the present invention, since the wavefront aberration is not generated in the outputted light from the intensity distribution switching part, the performance can be improved.

### BRIEF DESCRIPTION OF DRAWINGS

A purpose, an effect, and a characteristic of the above-mentioned invention will be more clarified based on Description and the attached drawings.

FIG. 1 is a view showing a configuration of a related optical head device.

FIGS. 2A and 2B are views showing cross-sections of a polarization lens of the related optical head device.

FIG. 3 is a view showing a configuration of an optical head device according to a first exemplary embodiment of the present invention.

FIGS. 4A and 4B are cross sections showing a polarization direction control element according to the first exemplary embodiment of the present invention.

FIG. 5 is a plane view showing the polarization direction control element according to the first exemplary embodiment of the present invention.

FIG. 6 is a view showing an intensity distribution of incoming light inputted to an intensity distribution switching part according to the exemplary embodiment of the present invention.

FIG. 7 is a view showing transmittance distribution of the intensity distribution switching part according to the exemplary embodiment of the present invention.

FIG. 8 is a view showing the intensity distribution of outputted light from the intensity distribution switching part according to the exemplary embodiment of the present invention.

FIG. 9 is a plane view showing a polarization direction control element according to a second exemplary embodiment of the present invention.

FIGS. 10A and 10B are views showing the intensity distribution of incoming light inputted to an intensity distribution switching part according to the exemplary embodiment of the present invention.

FIGS. 11A and 11B are views showing a transmittance distribution of the intensity distribution switching part according to the exemplary embodiment of the present invention.

FIGS. 12A and 12B are views showing the intensity distribution of outputted light from the intensity distribution switching part according to the exemplary embodiment of the present invention.

FIG. 13 is a plane view showing a polarization direction control element according to a third exemplary embodiment of the present invention.

FIG. 14 is a plane view showing a polarization direction control element according to a fourth exemplary embodiment of the present invention.

FIGS. 15A and 15B are cross sectional views showing a transmittance control element according to a fifth exemplary embodiment of the present invention.

FIG. 16 is a plane view showing the transmittance control element according to the fifth exemplary embodiment of the present invention.

FIG. 17 is a plane view showing a transmittance control element according to a sixth exemplary embodiment of the present invention.

FIG. 18 is a view showing a configuration of an optical information recording/reproducing device according to a seventh exemplary embodiment of the present invention.

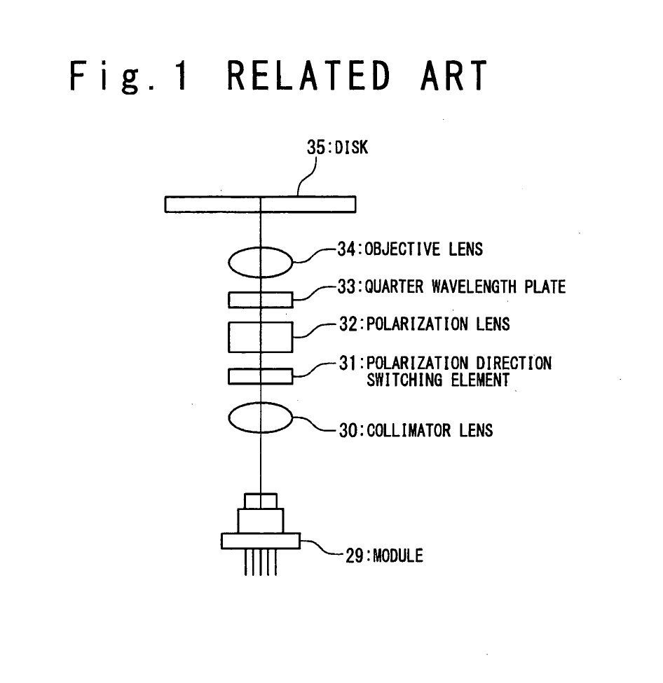

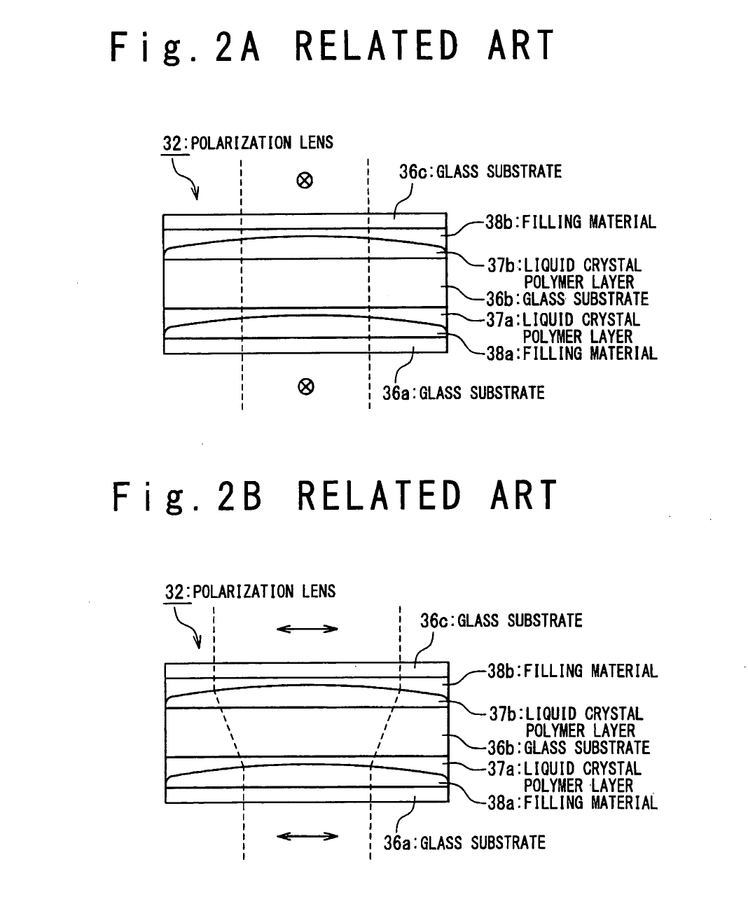

### BEST MODE FOR CARRYING OUT THE INVENTION

Referring to the drawings, exemplary embodiments of the present invention will be explained below.

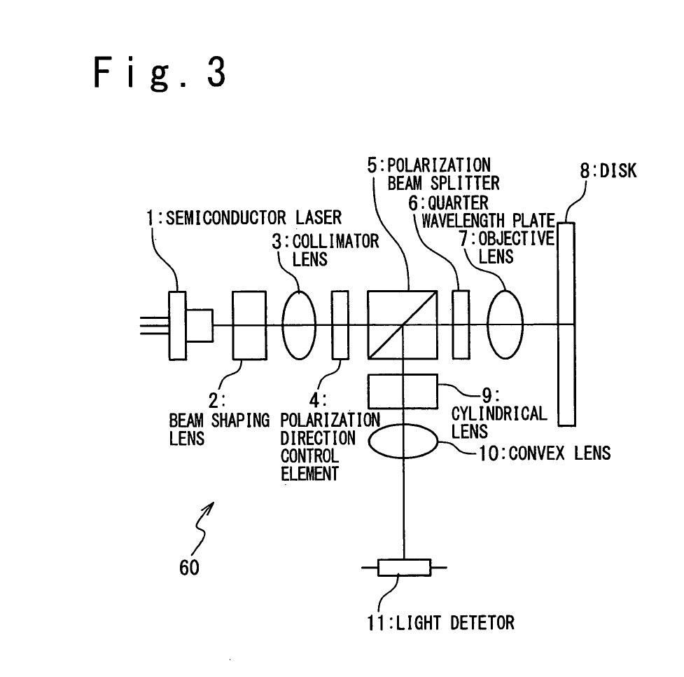

FIG. 3 shows a configuration of an optical head device according to a first exemplary embodiment of the present invention. The optical head device 60 includes a semiconductor laser 1, a beam shaping lens 2, a collimator lens 3, a polarization direction control element 4, a polarization beam splitter 5, a quarter wavelength plate 6, an objective lens 7, a cylindrical lens 9, a convex lens 10, and a light detector 11.

A cross-section shape of outputted light outputted from the semiconductor laser 1 that is a light source is converted from an ellipse shape to a circular shape with the beam shaping lens 2, and the outputted light is adjusted to be parallel light with the collimator lens 3. The light adjusted to be parallel light passes through the polarization direction control element 4, is inputted to the polarization beam splitter 5 that is a light separation part so that P-polarized component almost entirely transmits through the polarization beam splitter 5, is converted from linear polarized light to circular polarized light with the quarter wavelength plate 6, and is collected on a disk 8 that is an optical recording medium with the objective lens 7. Reflected light from the disk 8 passes through the objective lens 7 in an opposite direction, is converted by the quarter wavelength plate 6 from circular polarized light to linear polarized light whose polarization direction is perpendicular to that of light in the outward path, is inputted to the polarization beam splitter 5 as S-polarized light and is almost entirely reflected, passes through the cylindrical lens 9 and the convex lens 10, and is received by the light detector 11. In the present exemplary embodiment, the polarization direction control element 4 and the polarization beam splitter 5 constitutes an intensity distribution switching part. The polarization direction control element 4 includes a wavelength plate as described below.

The light detector 11 is provided at an intermediate position between two focal lines formed by the cylindrical lens 9 and the convex lens 10, and has four light-receiving parts separated by a separation line corresponding to a radius direction of the disk 8 and a separation line corresponding to a tangential line of the disk 8. A focus error signal, a track error signal, and a reproduction signal that is a mark/space signal recorded on the disk 8 are detected based on voltage signals outputted from the four light-receiving parts. The focus error signal is detected with the commonly-known astigmatism method, and the track error signal is detected with the commonly-known push-pull method. The reproduction signal is detected based on a high-frequency component in a summation of the voltage signals outputted from the four light-receiving parts.

A direction parallel to an active layer of the semiconductor laser 1 is represented by X direction, and a direction perpendicular to the active layer is represented by Y direction. In the outputted light from the semiconductor laser 1, a spread angle of a beam in the X direction is smaller than a spread angle of the beam in the Y direction. Accordingly, the cross-section shape of the outputted light is an ellipse shape in which a minor axis is in the X direction and a major axis is in the Y direction. The beam shaping lens 2 enlarges the spread angle of the beam in the X direction to conform to the spread angle of the beam in the Y direction, thereby the cross-section shape of the light in the outward path is converted from the ellipse shape into the circular shape. Here, the spread angle of the beam in the X direction in the semiconductor laser 1 is 8.5° (HWHM: Half Width at Half Maximum) and the spread angle of the beam in the Y direction is 20.0° (HWHM), and a magnification rate of the spread angle of the beam in the X direction in the beam shaping lens 2 is 2.35 times. In addition, a focal length of the collimator lens 3 is 12.2 mm, and a focal length of the objective lens is 3.0 mm. At this time, in case of not using the polarization direction control element 4, the rim intensity in the objective lens 7 becomes 0.55 in both of the X direction and the Y direction.

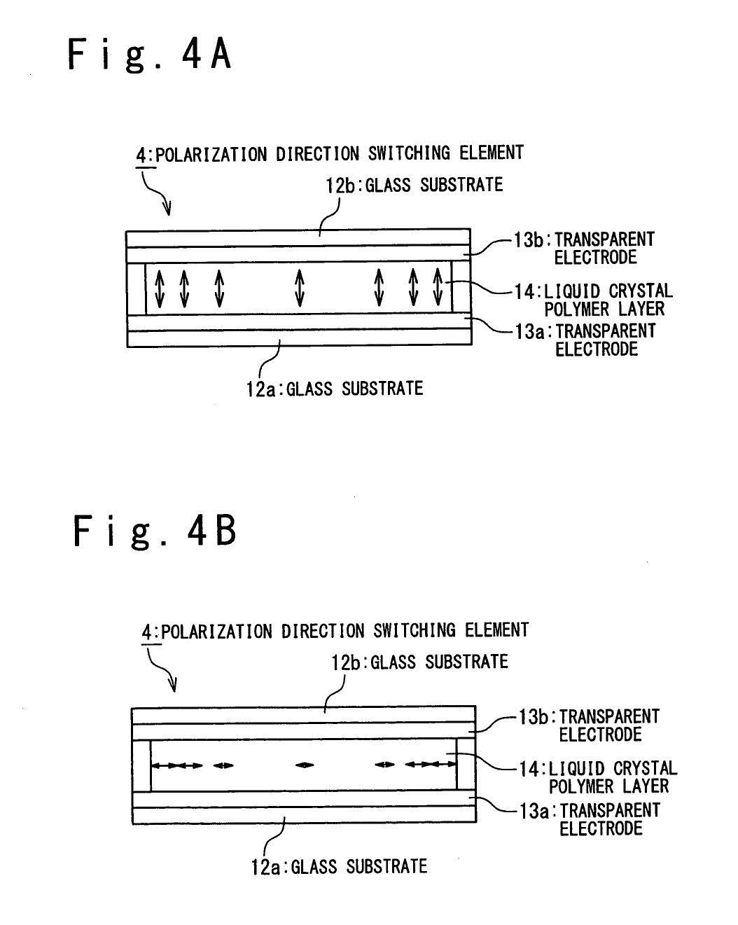

FIGS. 4A and 4B are cross sectional views showing the polarization direction control element 4. The polarization direction control element 4 has a configuration in which a liquid crystal polymer layer 14 is sandwiched between a glass substrate 12a and a glass substrate 12b. On surfaces of the glass substrates 12a and 12b, transparent electrodes 13a and 13b for applying an alternating-current voltage to the liquid crystal polymer layer 14 are respectively formed at the liquid crystal polymer layer 4 side. Arrowed lines in the drawings show a longitudinal direction of the liquid crystal polymer in the liquid crystal polymer layer 14. The liquid crystal polymer layer 14 has a uniaxial refractive index anisotropy so that a direction of an optical axis is along the longitudinal direction of the liquid crystal polymer. When a refractive index of the liquid crystal polymer with a polarization component parallel to the longitudinal direction (an extraordinary light component) is represented by “ne”, and a refractive index with a polarization component perpendicular to the longitudinal direction (an ordinary light component) is represented by “no”, the “ne” is larger than the “no”.

When an effective value of an alternating-current voltage applied between the transparent electrode 13a and the transparent electrode 13b is within a range from 3.5 V to 5 V, the longitudinal direction of the liquid crystal polymer in the liquid crystal polymer layer 14 is almost parallel to the optical axis of incoming light as shown in FIG. 4A. Accordingly, the reflective index of the liquid crystal polymer layer 14 with the incoming light becomes the “no”. On this occasion, the polarization direction control element 4 acts as a full wavelength plate that does not change a polarization direction of the incoming light. Meanwhile, in a case where the effective value of the alternating-current voltage applied between the transparent electrode 13a and the transparent electrode 13b is within a range from 0V to 1.5V, the longitudinal direction of the liquid crystal polymer in the liquid crystal polymer layer 14 is almost perpendicular to the optical axis of the incoming light as shown in FIG. 4B. Accordingly, the reflective index of the liquid crystal polymer layer 14 with the incoming light becomes the “ne” for the extraordinary light component, and becomes the “no” for the ordinary light component. Here, when a wavelength of the incoming light is represented by λ and a thickness of the liquid crystal polymer layer 15 is represented by t, a value of the thickness t is set to satisfy 2π(ne−no)t/λ=π. At this time, the polarization direction control element 4a acts as a half wavelength plate for changing the polarization direction of the incoming light by a predetermined angle.

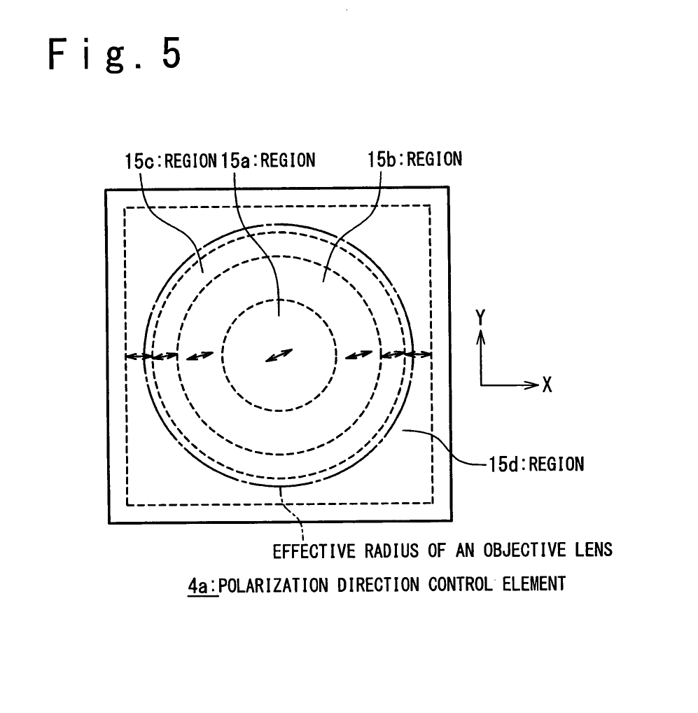

FIG. 5 is a plane view showing the polarization direction control element 4. As shown in FIG. 5, the polarization direction control element 4 according to the first exemplary embodiment is a polarization direction control element 4a, which is divided into four regions each of which is controlled. The liquid crystal polymer layer 14 in the polarization direction control element 4a is divided into four regions, which are regions 15a to 15d, by three concentric circles whose centers are the optical axis of the incoming light. An arrowed line in the drawing shows the longitudinal direction of the liquid crystal polymer in the liquid crystal polymer layer 14 in a case where the effective value of the alternating-current voltage applied between the transparent electrode 13a and the transparent electrode 13b is within a range from 0V to 1.5V. The longitudinal directions of the liquid crystal polymers are different from each other between the regions 15a to 15d, the direction in the region 15d coincides to the X direction, and angles with the X direction in the regions 15c, 15b, and 15a become larger in this order.

Here, the polarization direction of the incoming light coincides to the X direction. On this occasion, when the angle of the longitudinal direction of the liquid crystal polymer in the liquid crystal polymer layer 14 with the X direction is represented by α, the polarization direction control element 4a acts as the half wavelength plate for changing the polarization direction of the incoming light by 2α. However, the value of α is different between the regions 15a to 15d. Here, when a numeral aperture of the objective lens 7 is 0.65, an effective radius of the objective lens 7 is “3 mm×0.65=1.95 mm” as shown by a dashed line in FIG. 5. In addition, a radius of a circle formed on a boundary between the region 15a and the region 15b is 0.86 mm, a radius of a circle formed on a boundary between the region 15b and the region 15c is 1.44 mm, and a radius of a circle formed on a boundary between the region 15c and the region 15d is 1.81 mm. Moreover, the values of α in the regions 15a, 15b, 15c, and 15d are 17.0°, 13.6°, 9.4°, and 0°, respectively.

The polarization direction of P-polarized light with the polarization beam splitter 5 coincides to the X direction. In a case where an effective value of the alternating-current voltage applied between the transparent electrode 13a and the transparent electrode 13b of the polarization direction control element 4a is within a range from 3.5V to 5V, the incoming light inputted to the polarization beam splitter 5 becomes P-polarized light and almost entirely transmits through the polarization beam splitter 5. On the other hand, when the effective value of the alternating-current voltage applied between the transparent electrode 13a and the transparent electrode 13b of the polarization direction control element 4a is within a range from 0V to 1.5V, the incoming light inputted to the polarization beam splitter 5 becomes linear polarized light, in which the polarization direction is changed by 2α from that of the P-polarized light, and transmits through the polarization beam splitter 5 at a transmittance of cos² 2α. The values of α are different between the regions 15a to 15d.

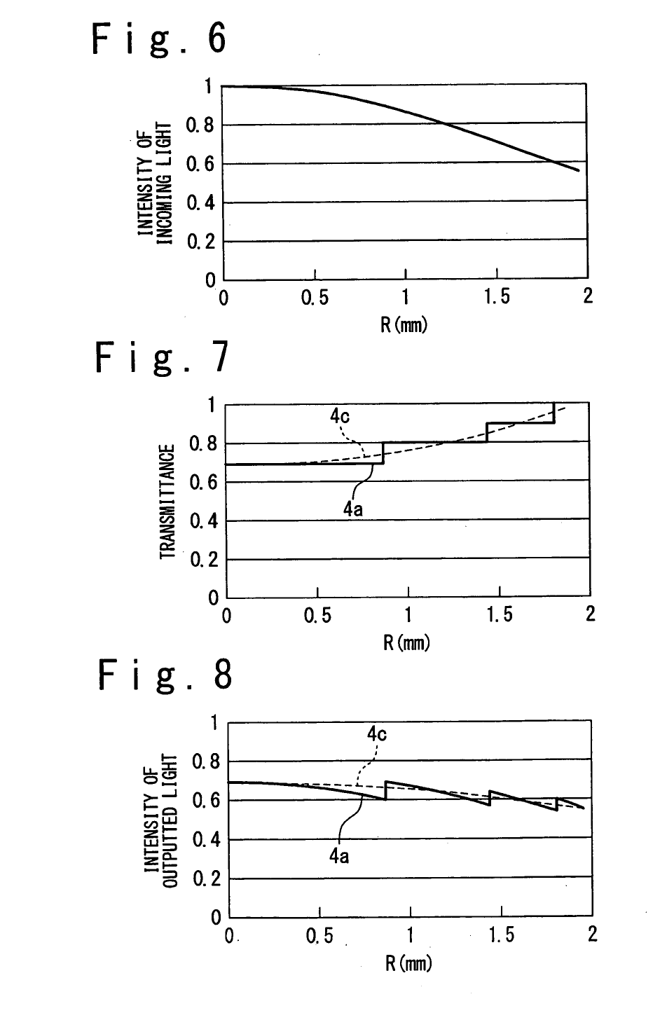

An intensity distribution of the incoming light toward the intensity distribution switching part including the polarization direction control element 4a and the polarization beam splitter 5, a transmittance distribution of the intensity distribution switching part, and an intensity distribution of the outputted light from the intensity distribution switching part are shown in FIGS. 6 to 8. Lateral axes R in the respective drawings represent a distance from the optical axis in a cross-section perpendicular to the optical axis, and longitudinal axes in the respective drawings represent intensity of the incoming light, the transmittance, and intensity of the outputted light in a cross-section passing the optical axis.

FIG. 6 shows the intensity distribution of the incoming light toward the intensity distribution switching part. When the intensity of light passing through a center of the objective lens 7 (R=0 mm) is represented by 1, the intensity of the light passing through a rim of the objective lens (R=1.95 mm) becomes 0.55. In a case where the effective value of the alternating-current voltage applied between the transparent electrode 13a and the transparent electrode 13b of the polarization direction control element 4a is within a range from 3.5V to 5V, the transmittance of the intensity distribution switching part becomes 1, regardless of the distance R from the optical axis. At this time, the intensity distribution of the outputted light from the intensity distribution switching part is the same as that shown in FIG. 6. Accordingly, the rim intensity in the objective lens 7 becomes 0.55. On the other hand, in the case where the effective value of the alternating-current voltage applied between the transparent electrode 13a and the transparent electrode 13b of the polarization direction control element 4a is within a range from 0V to 1.5V, the transmittance distribution of the intensity distribution switching part is shown by a solid line in FIG. 7. Specifically, the transmittance is 0.69 in a range of “0 mm<R<0.86 mm”, the transmittance is 0.79 in a range of “0.86 mm<R<1.44 mm”, the transmittance is 0.90 in a range of “1.44 mm<R<1.81 mm”, and the transmittance is 1 in a range of “1.81 mm<R<1.95 mm”. At this time, the intensity distribution of the outputted light from the intensity distribution switching part is shown by a solid line in FIG. 8. The intensity of the light passing through the center of the objective lens 7 (R=0 mm) is 0.69, and the intensity of the light passing through the rim of the objective lens 7 (R=1.95 mm) is 0.55. Accordingly, the rim intensity in the objective lens 7 becomes 0.80.

Here, a wavelength of the outputted light from the semiconductor laser 1 is 405 nm. In case of recording information to the disk 8, the effective value of the alternating-current voltage applied between the transparent electrode 13a and the transparent electrode 13b of the polarization direction control element 4a is set to be within a range from 3.5 V to 5 V. Accordingly, the rim intensity in the objective lens 7 becomes 0.55. At this time, the diameter of the condensed spot formed on the disk 8 becomes 0.529 μm (1/e² Full width), and the efficiency of the optical system in the outward path becomes 45.0%. On the other hand, in case of reproducing information from the disk 8, the effective value of the alternating-current voltage applied between the transparent electrode 13a and the transparent electrode 13b of the polarization direction control element 4a is set to be within the range from 0 V to 1.5 V. Accordingly, the rim intensity in the objective lens 7 becomes 0.80. At this time, the diameter of the condensed spot formed on the disk 8 becomes 0.518 μm (1/e² Full width), and the efficiency of the optical system in the outward path becomes 36.7%. That is, the diameter of the condensed spot can be increased by reducing the rim intensity the efficiency of the optical system in the outward path can be increased in a case of recording information on the disk 8, and the diameter of the condensed spot can be reduced by increasing the rim intensity, the efficiency of the optical system can be slightly reduced in a case of reproducing information from the disk 8.

In an optical head device according to a second exemplary embodiment of the present invention, the beam shaping lens 2 of the optical head device 6 shown in FIG. 3 is deleted, and the polarization direction control element 4 is replaced to a polarization direction control element 4b. Because of the deletion of the beam shaping lens 2, the cross-section shape of the light in the outward path is an ellipse shape where a minor axis is the X direction and a major axis is the Y direction. Here, the spread angle of the beam in the X direction in the semiconductor laser 1 is 8.5° (HWHM) and the spread angle of the beam in the Y direction is 20.0° (HWHM). In addition, a focal length of the collimator lens 3 is 20.0 mm, and a focal length of the objective lens 7 is 3.0 mm. At this time, the rim intensity in the objective lens 7 in a case of not using the polarization direction control element 4b becomes 0.30 in the X direction and becomes 0.80 in the Y direction.

A cross-section of the polarization direction control element 4b is the same as those shown in FIGS. 4A and 4B. In the case where the effective value of the alternating-current voltage applied between the transparent electrode 13a and the transparent electrode 13b is within a range from 3.5V to 5V, the polarization direction control element 4b acts as the full wavelength plate that does not change the polarization direction of the incoming light. On the other hand, in the case where the effective value of the alternating-current voltage applied between the transparent electrode 13a and the transparent electrode 13b is within a range from 0V to 1.5V, the polarization direction control element 4b acts as the half wavelength plate that changes the polarization direction of the incoming light by the predetermined angle.

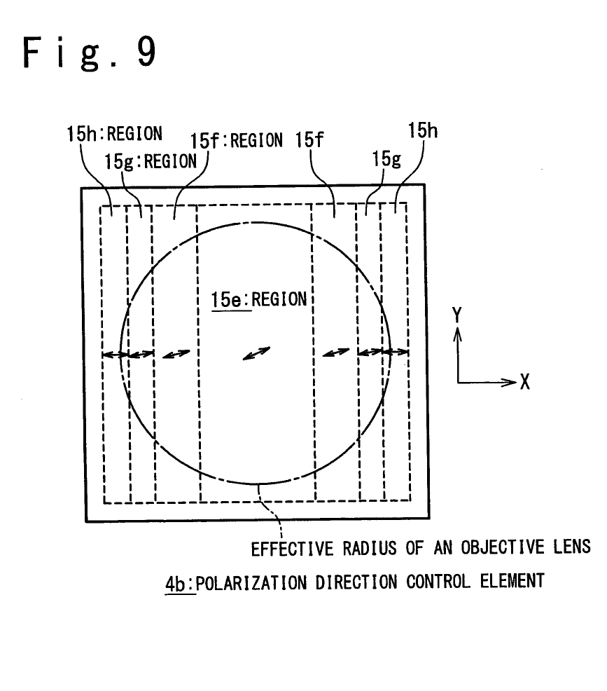

FIG. 9 is a plane view showing the polarization direction control element 4b. The liquid crystal polymer layer 14 in the polarization direction control element 4b is divided into seven regions by six straight lines which are symmetric to the optical axis and parallel to the Y direction. Among them, the region including the optical axis is represented by a region 15e, the two regions positioning at both sides of the region 15e are represented by regions 15f, two regions positioning on sides of the regions 15f and opposite to the regions 15e are represented by regions 15g, and two regions positioning on sides of the regions 15g and opposite to the regions 15f are represented by regions 15h. An arrowed line in the drawing shows the longitudinal direction of the liquid crystal polymer in the liquid crystal polymer layer 14 in the case where the effective value of the alternating-current voltage applied between the transparent electrode 13a and the transparent electrode 13b is within a range from 0V to 1.5V. The longitudinal directions of the liquid crystal polymers are different from each other between the regions 15e to 15h, the longitudinal direction in the region 15h coincides to the X direction, and angles of the longitudinal directions with the X direction in the regions 15g, 15f, and 15e become larger in this order.

Here, the polarization direction of the incoming light coincides to the X direction. On this occasion, when the angle of the longitudinal direction of the liquid crystal polymer in the liquid crystal polymer layer 14 with the X direction is a, the polarization direction control element 4b acts as the half wavelength plate for changing the polarization direction of the incoming light by 2α. However, the value of α is different between the regions 15e to 15h. Here, when the numeral aperture of the objective lens 7 is 0.65, the effective radius of the objective lens 7 is “3 mm×0.65=1.95 mm” as shown by a dashed line in FIG. 9. In addition, a distance from the optical axis to a straight line formed on a boundary between the region 15e and the region 15f is 0.97 mm, a distance from the optical axis to a straight line formed on a boundary between the region 15f and the region 15g is 1.53 mm, and a distance from the optical axis to a straight line on a boundary between the region 15g and the region 15h is 1.84 mm. The values of α in the regions 15e, 15f, 15g, and 15h are 26.1°, 20.1°, 13.6°, and 0°, respectively.

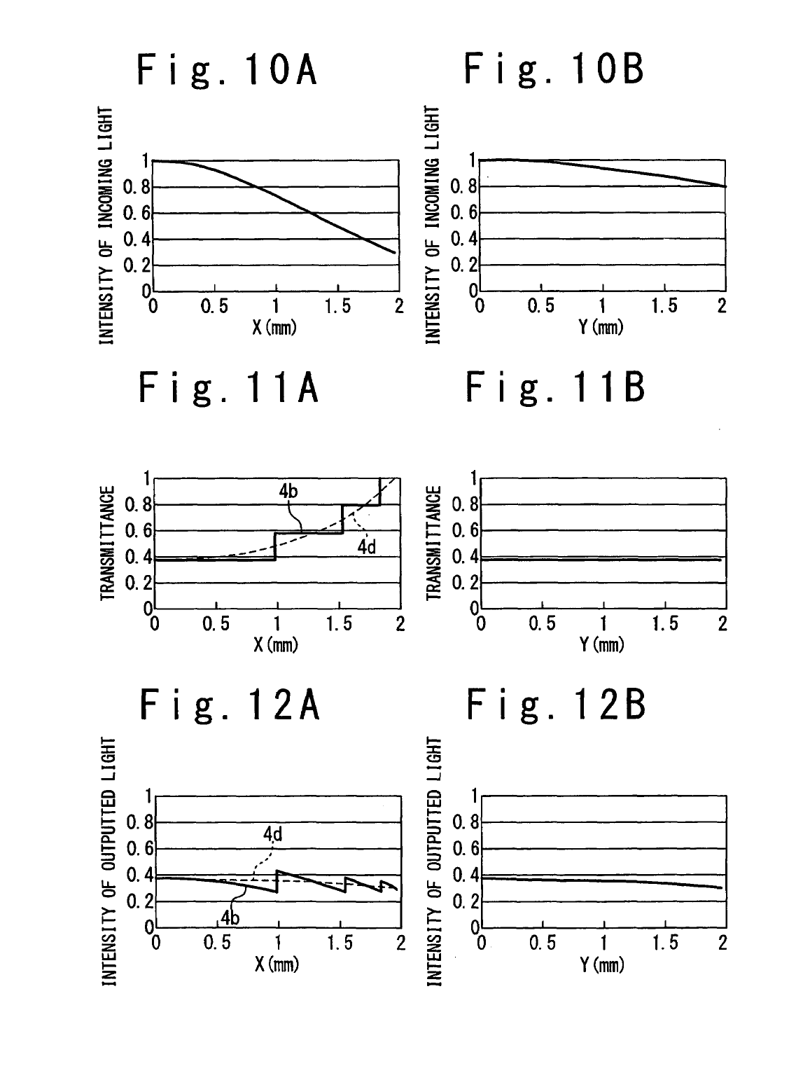

An intensity distribution of the incoming light toward the intensity distribution switching part constituted by the polarization direction control element 4b and the polarization beam splitter 5, a transmittance distribution of the intensity distribution switching part, and an intensity distribution of the outputted light from the intensity distribution switching part are shown in FIGS. 10A and 10B to FIGS. 12A and 12B. A lateral axis X and a lateral axis Y in the drawings respectively represent X-direction component and Y direction component of distance from the optical axis in the cross-section perpendicular to the optical axis, and longitudinal axes in FIGS. 10A and 10B to FIGS. 12A and 12B respectively represent intensity of the incoming light, the transmittance, and the intensity of the outputted light in cross-sections respectively passing the optical axis in the X direction and the Y direction.

FIGS. 10A and 10B show the intensity distribution of the incoming light toward the intensity distribution switching part. When the intensity of the light passing through a center of the objective lens 7 (X=0 mm, Y=0 mm) is 1, the intensity of the light passing through a rim in the X direction of the objective lens 7 (X=1.95 mm, Y=0 mm) is 0.30 (refer to FIG. 10A) and the intensity of the light passing through a rim in the Y direction of the objective lens 7 (X=0 mm, Y=1.95 mm) is 0.80 (refer to FIG. 10B). In the case where the effective value of the alternating-current voltage applied between the transparent electrode 13a and the transparent electrode 13b of the polarization direction control element 4b is within a range from 3.5V to 5V, the transmittance of the intensity distribution switching part is 1 regardless of the X and Y. At this time, the intensity distribution of the outputted light from the intensity distribution switching part is the same as that shown in FIGS. 10A and 10B. Accordingly, the rim intensity in the objective lens 7 becomes 0.30 in the X direction and becomes 0.80 in the Y direction. On the other hand, in the case where the effective value of the alternating-current voltage applied between the transparent electrode 13a and the transparent electrode 13b of the polarization direction control element 4b is within a range from 0V to 1.5V, the transmittance distribution of the intensity distribution switching part is shown by a solid line of FIG. 11A regarding the X direction, and is shown by a solid line in FIG. 11B regarding the Y direction. That is, the transmittance is 0.37 in a range of “0 mm<R<0.97 mm”, the transmittance is 0.58 in a range of “0.97 mm<R<1.53 mm”, the transmittance is 0.79 in a range of “1.53 mm<R<1.84 mm”, and the transmittance is 1 in a range of “1.84 mm<R<1.95 mm”. At this time, the intensity distribution of the outputted light from the intensity distribution switching part is shown by a solid line in FIG. 12A regarding the X direction, and is shown by a solid line in FIG. 12B regarding the Y direction. That is, the intensity of the light passing through the center of the objective lens 7 (X=0 mm, Y=0 mm) is 0.37, the intensity of the light passing through the rim of the objective lens 7 in the X direction (X=1.95 mm, Y=0 mm) is 0.30, and the intensity of the light passing through the rim of the objective lens 7 in the Y direction (X=0 mm, Y=1.95 mm) is 0.30. Accordingly, the rim intensity in the objective lens 7 is 0.80 regarding the X direction and is 0.80 regarding the Y direction.

Here, a wavelength of the outputted light from the semiconductor laser 1 is 405 nm. In case of recording information to the disk 8, the effective value of the alternating-current voltage applied between the transparent electrode 13a and the transparent electrode 13b of the polarization direction control element 4b is set to be within a range from 3.5 V to 5 V. Accordingly, the rim intensity in the objective lens 7 becomes 0.30 regarding the X direction and becomes 0.80 regarding the Y direction. At this time, the diameter of the condensed spot formed on the disk 8 becomes 0.557 μm (1/e² Full width) regarding the X direction and becomes 0.508 μm (1/e² Full width) regarding the Y direction, and the efficiency of the optical system in the outward path becomes 37.6%. On the other hand, in case of reproducing information from the disk 8, the effective value of the alternating-current voltage applied between the transparent electrode 13a and the transparent electrode 13b of the polarization direction control element 4b is set to be within a range from 0 V to 1.5 V. Accordingly, the rim intensity in the objective lens 7 becomes 0.80 regarding the X direction and becomes 0.80 regarding the Y direction. At this time, the diameter of the condensed spot formed on the disk 8 becomes 0.515 μm (1/e² Full width) regarding the X direction and becomes 0.520 μm (1/e² Full width) regarding the Y direction, and the efficiency of the optical system in the outward path becomes 16.9%. That is, slightly increasing the diameter of the condensed spot regarding to the X direction and increasing the efficiency of the optical system in the outward path can be realized by reducing the rim intensity regarding the X direction in case of the recording, and reducing the diameter of the condensed spot in the X direction and slightly reducing the efficiency of the optical system in the outward path can be realized by increasing the rim intensity regarding the X direction in case of the reproducing.

In the polarization direction control element 4a according to the first exemplary embodiment and the polarization direction control element 4b according to the second exemplary embodiment, the liquid crystal polymer layer, which is divided into a plurality of regions, and the transparent electrodes 13a and 13b, which are constituted by single regions for sandwiching the liquid crystal polymer layers, are employed, and the polarization directions are changed by changing the longitudinal directions of the respective regions of the liquid crystal polymer layers at the time of reproducing. On the other hand, an ellipticity of the incoming light can be changed in the polarization direction control element at the time of reproducing, by employing a liquid crystal polymer layer including a single region and a transparent electrode divided into a plurality of regions for sandwiching the liquid crystal polymer layer and changing the effective value of the alternating-current voltage applied to the respective regions of the transparent electrodes.

In that case, the effective value of the alternating-current voltage applied to the transparent electrode is set to be within a range from 3.5V to 5V at the time of recording. In this case, the longitudinal direction of the liquid crystal polymer is almost parallel to the optical axis of the incoming light. At this time, the polarization direction control element does not change the ellipticity of the incoming light, and the incoming light toward the polarization beam splitter almost entirely transmits through the polarization beam splitter. Meanwhile, at the time of reproducing, the effective value of the alternating-current voltage applied to the transparent electrode is set to be within a range from 1.5V to 3.5V. In this case, an angle of the longitudinal direction of the liquid crystal polymer with a direction perpendicular to the optical axis of the incoming light becomes a predetermined angle, in a plane including the optical axis of the incoming light and defining an angle of 45° with the polarization direction of the incoming light. This angle changes almost-linearly with the effective value of the alternating-current voltage. At this time, the polarization direction control element changes the ellipticity of the incoming light based on the effective value of the alternating-current, and the incoming light inputted to the polarization beam splitter transmits through the polarization beam splitter at the transmittance based on the effective value of the alternating-current voltage. However, since the effective values of the alternating-current voltages are different from each other between a plurality of the regions of the transparent electrode, an amount of change of the ellipticity of the incoming light toward the polarization direction control element, and the transmittance of the polarization beam splitter are different from each other between a plurality of the regions in the transparent electrode.

In an optical head device according to a third exemplary embodiment of the present invention, the polarization direction control element 4 of the optical head device 6 shown in FIG. 3 is replaced to a polarization direction control element 4c. The beam shaping lens 2 converts a cross-section shape of the light in the outward path from an ellipse shape into a circular shape. Here, a spread angle of the beam in the X direction in the semiconductor laser 1 is 8.5° (HWHM), the spread angle of the beam in the Y direction is 20.0° (HWHM), and a magnification rate of the spread angle of the beam in the X direction in the beam shaping lens 2 is 2.35 times. In addition, a focal length of the collimator lens 3 is 12.2 mm, and a focal length of the objective lens 7 is 3.0 mm. At this time, in a case of not using the polarization direction control element 4c, the rim intensity in the objective lens 7 is 0.55 in both of the X direction and the Y direction.

A cross-section of the polarization direction control element 4c is the same as those shown in FIGS. 4A and 4B. In the case where the effective value of the alternating-current voltage applied between the transparent electrode 13a and the transparent electrode 13b is within a range from 3.5V to 5V, the polarization direction control element 4c acts as the full wavelength plate that does not change the polarization direction of the incoming light. On the other hand, in the case where the effective value of the alternating-current voltage applied between the transparent electrode 13a and the transparent electrode 13b is within a range from 0V to 1.5V, the polarization direction control element 4c acts as the half wavelength plate that changes the polarization direction of the incoming light by a predetermined angle.

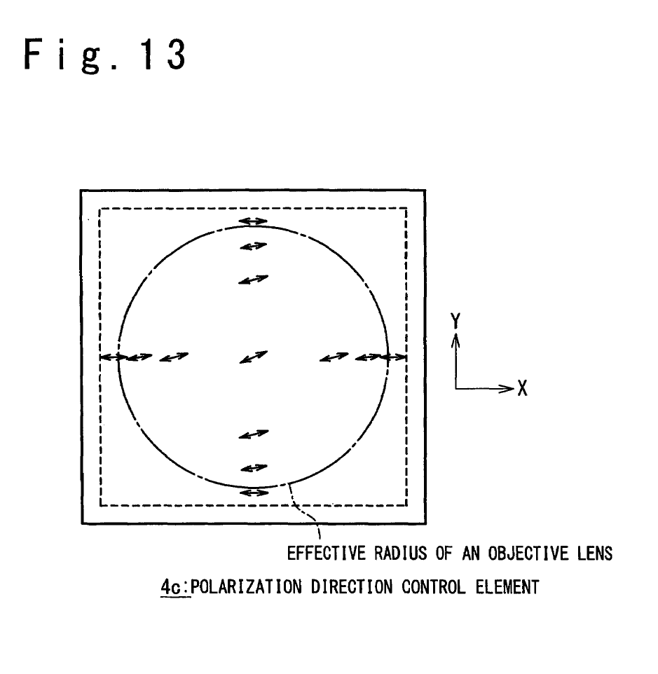

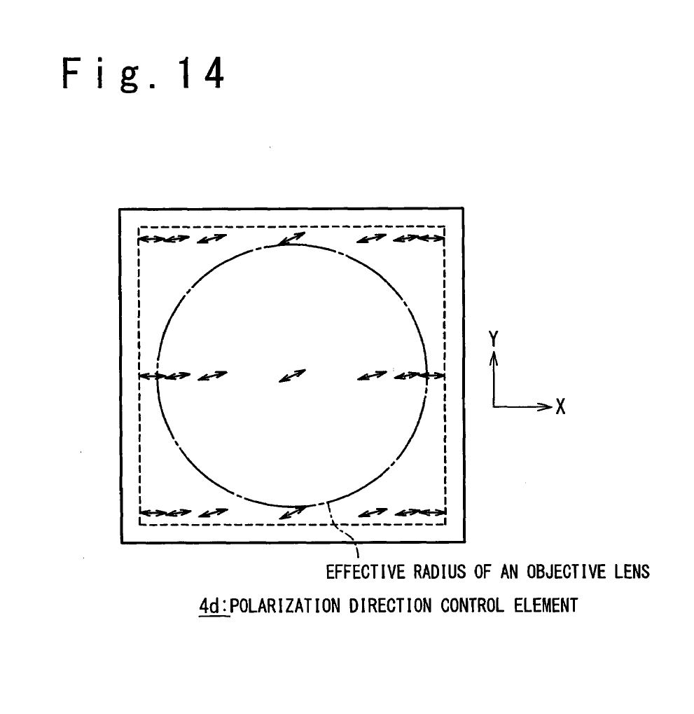

FIG. 13 is a plane view showing the polarization direction control element 4c. An arrowed line in the drawing shows a longitudinal direction of the liquid crystal polymer of the liquid crystal polymer layer 14 in a case where the effective value of the alternating-current voltage applied between the transparent electrode 13a and the transparent electrode 13b is within a range from 0V to 1.5V. The longitudinal direction of the liquid crystal polymer coincides to the X direction at a position where the distance from the optical axis is equal to an effective radius of the objective lens 7, however, an angle with the X direction becomes larger as a distance from the optical axis becomes shorter.

Here, the polarization direction of the incoming light coincides to the X direction. On this occasion, when an angle of the longitudinal direction of the liquid crystal polymer in the liquid crystal polymer layer 14 with the X direction is α, the polarization direction control element 4c acts as the half wavelength plate for changing the polarization direction of the incoming light by 2α. However, the value of α varies depending on a distance from the optical axis. Here, when the numeral aperture of the objective lens 7 is 0.65, an effective radius of the objective lens 7 becomes “3 mm×0.65=1.95 mm” as shown by a dashed line in FIG. 13. In addition, when the distance from the optical axis is R (mm), the value of α is determined so as to satisfy an expression of cos² 2α=0.55/0.80×exp [log (0.80/0.55)×(R/1.95)²].

In the case where the effective value of the alternating-current voltage applied between the transparent electrode 13a and the transparent electrode 13b of the polarization direction control element 4c is within a range from 3.5V to 5V, the transmittance of the intensity distribution switching part becomes 1, regardless of the distance R. At this time, the intensity distribution of the outputted light from the intensity distribution switching part is the same as that shown in FIG. 6. Accordingly, the rim intensity in the objective lens 7 becomes 0.55. On the other hand, in the case where the effective value of the alternating-current voltage applied between the transparent electrode 13a and the transparent electrode 13b of the polarization direction control element 4c is within a range from 0V to 1.5V, the transmittance distribution of the intensity distribution switching part is shown by a solid line in FIG. 7. Specifically, the transmittance monotonically increases as the distance R from the optical axis increases, the transmittance becomes 0.69 in case of R=0 mm, and the transmittance becomes 1 in case of R=1.95 mm. At this time, the intensity distribution of the incoming light from the intensity distribution switching part is shown by a solid line in FIG. 8. The intensity of the light passing through the center of the objective lens 7 (R=0 mm) becomes 0.69, the intensity of the light passing through the rim of the objective lens 7 (R=1.95 mm) becomes 0.55. Accordingly, the rim intensity in the objective lens 7 becomes 0.80.

Here, a wavelength of the outputted light from the semiconductor laser 1 is 405 nm. In case of recording information to the disk 8, the effective value of the alternating-current voltage applied between the transparent electrode 13a and the transparent electrode 13b of the polarization direction control element 4c is set to be within a range from 3.5 V to 5 V. Accordingly, the rim intensity in the objective lens 7 becomes 0.55. At this time, the diameter of the condensed spot formed on the disk 8 becomes 0.529 μm (1/e² Full width), and the efficiency of the optical system in the outward path becomes 45.0%. On the other hand, in case of reproducing information from the disk 8, the effective value of the alternating-current voltage applied between the transparent electrode 13a and the transparent electrode 13b of the polarization direction control element 4c is set to be within a range from 0 V to 1.5 V. Accordingly, the rim intensity in the objective lens 7 becomes 0.80. At this time, the diameter of the condensed spot formed on the disk 8 becomes 0.519 μm (1/e² Full width), and the efficiency of the optical system in the outward path becomes 36.8%. That is, slightly increasing the diameter of the condensed spot and increasing the efficiency of the outward path can be realized by reducing the rim strength in case of recording information on the disk 8, and reducing the diameter of the condensed spot and slightly reducing the efficiency of the outward path can be realized by increasing the rime strength in case of reproducing information from the disk 8.

In an optical head device according to a fourth exemplary embodiment of the present invention, the beam shaping lens 2 of the optical head device 6 shown in FIG. 3 is deleted, and the polarization direction control element 4 is replaced to a polarization direction control element 4d. Because of the deletion of the beam shaping lens 2, a cross-section shape of the light in the outward path is an ellipse shape where a minor axis is in the X direction and a major axis is in the Y direction. Here, the spread angle of the beam in the X direction at the semiconductor laser 1 is 8.5° (HWHM) and the spread angle of the beam in the Y direction is 20.0° (HWHM). In addition, a focal length of the collimator lens 3 is 20.0 mm, and a focal length of the objective lens 7 is 3.0 mm. At this time, in case of not using the polarization direction control element 4d, the rim intensity in the objective lens 7 becomes 0.30 in the X direction and becomes 0.80 in the Y direction.

A cross-section of the polarization direction control element 4d is the same as that shown in FIGS. 4A and 4B. In the case where the effective value of the alternating-current voltage applied between the transparent electrode 13a and the transparent electrode 13b is within a range from 3.5V to 5V, the polarization direction control element 4d acts as the full wavelength plate that does not change the polarization direction of the incoming light. On the other hand, in the case where the effective value of the alternating-current voltage applied between the transparent electrode 13a and the transparent electrode 13b is within a range from 0V to 1.5V, the polarization direction control element 4d acts as the half wavelength plate that changes the polarization direction of the incoming light by a predetermined angle.

FIG. 14 is a plane view showing the polarization direction control element 4d. An arrowed line in the drawing shows the longitudinal direction of the liquid crystal polymer in the liquid crystal polymer layer 14 in a case where the effective value of the alternating-current voltage applied between the transparent electrode 13a and the transparent electrode 13b is within a range from 0V to 1.5V. The longitudinal direction of the liquid crystal polymer coincides to the X direction at a position when the distance from the optical axis is equal to the effective radius of the objective lens 7, however, an angle of the longitudinal direction with the X direction becomes larger when the distance from the optical axis becomes smaller.

Here, the polarization direction of the incoming light coincides to the X direction. On this occasion, when an angle of the longitudinal direction of the liquid crystal polymer of the liquid crystal polymer layer 14 with the X direction is α, the polarization direction control element 4d acts as the half wavelength plate for changing the polarization direction of the incoming light by 2α. However, the value of α is varied depending on X direction component of the distance from the optical axis. Here, when the numeral aperture of the objective lens 7 is 0.65, an effective radius of the objective lens 7 is “3 mm×0.65=1.95 mm” as shown by a dashed line in FIG. 14. In addition, when the X direction component and the Y direction component of the distance from the optical axis are respectively X (mm) and Y (mm), the value of α is determined so as to satisfy an expression of cos² 2α=0.30/0.80×exp [log (0.80/0.30)×(X/1.95)²].

In a case where the effective value of the alternating-current voltage applied between the transparent electrode 13a and the transparent electrode 13b of the polarization direction control element 4d is within a range from 3.5V to 5V, the transmittance of the intensity distribution switching part becomes 1 regardless of the X and Y. At this time, the intensity distribution of the outputted light from the intensity distribution switching part is the same as those shown in FIGS. 10A and 10B. Accordingly, the rim intensity in the objective lens 7 becomes 0.30 regarding the X direction and becomes 0.80 regarding the Y direction. On the other hand, in a case where the effective value of the alternating-current voltage applied between the transparent electrode 13a and the transparent electrode 13b of the polarization direction control element 4d is within a range from 0V to 1.5V, the transmittance distribution of the intensity distribution switching part is shown by a solid line in FIG. 11A regarding the X direction, and is shown by a solid line in FIG. 11B regarding the Y direction. Specifically, the transmittance monotonically increases as the X increases, the transmittance is 0.37 in case of X=0 mm, and the transmittance is 1 in case of X=1.95 mm. At this time, the intensity distribution of the incoming light from the intensity distribution switching part is shown by a dotted line in FIG. 12A regarding the X direction, and is shown by a solid line in FIG. 12B regarding the Y direction. The intensity of the light passing through the center of the objective lens 7 (X=0 mm, Y=0 mm) is 0.37, the intensity of the light passing through the rim of the objective lens 7 in the X direction (X=1.95 mm, Y=0 mm) is 0.30, and the intensity of the light passing through the rim of the objective lens 7 in the Y direction (X=0 mm, Y=1.95 mm) is 0.30. Accordingly, the rim intensity in the objective lens 7 becomes 0.80 regarding the X direction and becomes 0.80 regarding the Y direction.

Here, a wavelength of the outputted light from the semiconductor laser 1 is 405 nm. In the case of recording information on the disk 8, the effective value of the alternating-current voltage applied between the transparent electrode 13a and the transparent electrode 13b of the polarization direction control element 4d is set to be within a range from 3.5 V to 5 V. Accordingly, the rim intensity in the objective lens 7 becomes 0.30 regarding the X direction and becomes 0.80 regarding the Y direction. At this time, the diameter of the condensed spot formed on the disk 8 becomes 0.557 μm (1/e² Full width) regarding the X direction and becomes 0.508 μm (1/e² Full width) regarding the Y direction, and the efficiency of the optical system in the outward path becomes 37.6%. On the other hand, in the case of reproducing information from the disk 8, the effective value of the alternating-current voltage applied between the transparent electrode 13a and the transparent electrode 13b of the polarization direction control element 4d is set to be within a range from 0 V to 1.5 V. Accordingly, the rim intensity in the objective lens 7 becomes 0.80 regarding the X direction and becomes 0.80 regarding the Y direction. At this time, the diameter of the condensed spot formed on the disk 8 becomes 0.519 μm (1/e² Full width) regarding the X direction and becomes 0.519 μm (1/e² Full width) regarding the Y direction, and the efficiency of the optical system in the outward path becomes 17.4%. That is, slightly increasing the diameter of the condensed spot regarding the X direction and increasing the efficiency of the optical system in the outward path can be realized by reducing the rim intensity regarding the X direction in case of the recording, and reducing the diameter of the condensed spot regarding the X direction and slightly reducing the efficiency of the optical system in the outward path can be realized by increasing the rim intensity regarding the X direction in case of the reproducing.

In an optical head device according to a fifth exemplary embodiment of the present invention, the polarization direction control element 4 of the optical head device 6 shown in FIG. 3 is replace to a transmittance control element 16a. In the present exemplary embodiment, the intensity distribution switching part is configured by the transmittance control element 16a. The transmittance control element 16a includes a diffractive grating as described later. The beam shaping lens 2 converts a cross-section shape of the light in the outward path from an ellipse shape into a circular shape. Here, the spread angle of the beam in the X direction in the semiconductor laser 1 is 8.5° (HWHM), the spread angle of the beam in the Y direction is 20.0° (HWHM), and a magnification rate of the spread angle of the beam in the X direction in the beam shaping lens 2 is 2.35 times. In addition, a focal length of the collimator lens 3 is 12.2 mm, and a focal length of the objective lens 7 is 3.0 mm. At this time, in case of not using the transmittance control element 16a, the rim intensity in the objective lens 7 is 0.55 in both of the X and Y directions.

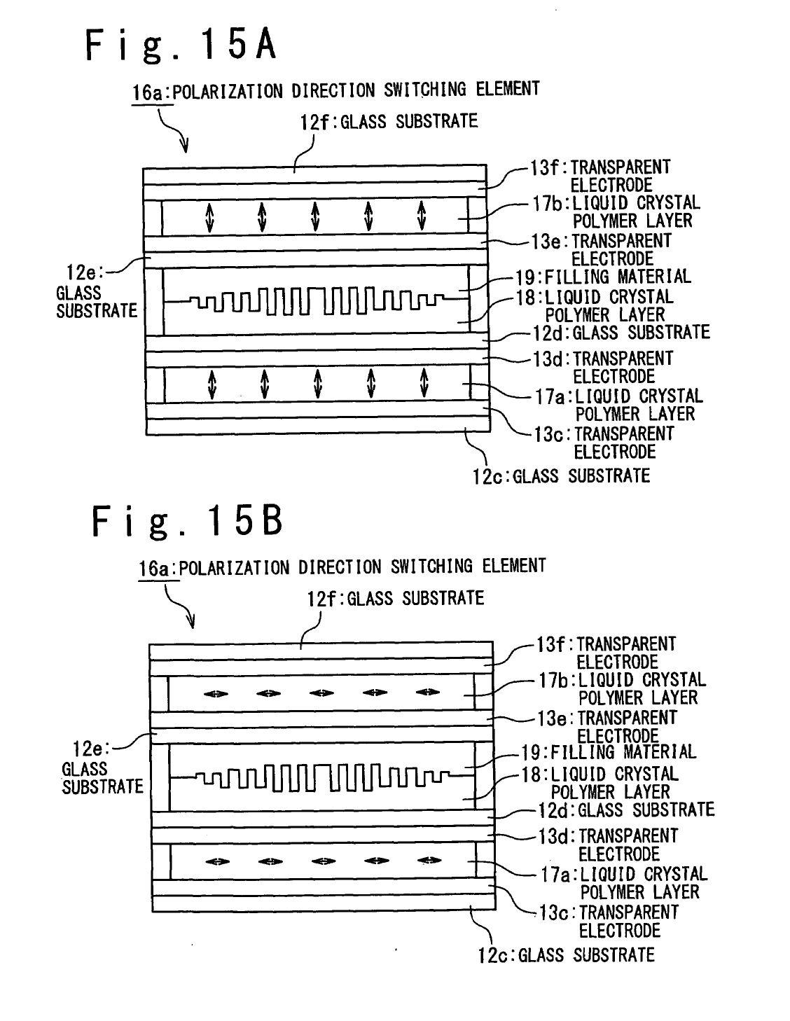

FIGS. 15A and 15B are cross sectional views showing the transmittance control element 16a. The transmittance control element 16a has a configuration, in which a liquid crystal polymer layer 17a is sandwiched between a glass substrate 12c and a glass substrate 12d, a liquid crystal polymer layer 18 and a filling material 19 are sandwiched between the glass substrate 12d and a glass substrate 12e, and a liquid crystal polymer layer 17b is sandwiched between the glass substrate 12e and a glass substrate 12f. Transparent electrodes 13c and 13d for applying an alternating-current voltage to the liquid crystal polymer layer 17a are respectively formed on the surfaces of the glass substrates 12c and 12d on a liquid crystal polymer layer 17a side, and transparent electrodes 13e and 13f for applying an alternating-current voltage to the liquid crystal polymer layer 17b are respectively formed on the surfaces of the glass substrates 12e and 12f on a liquid crystal polymer layer 17b side. Arrowed lines in the drawings show longitudinal directions of the liquid crystal polymers in the liquid crystal polymer layers 17a and 17b. In addition, a diffractive grating is formed on a boundary between the liquid crystal polymer layer 18 and the filling material 19. The liquid crystal polymer layers 17a, 17b, and 18 have a uniaxial refractive index anisotropy in which a direction of the optical axis is along the longitudinal direction of the liquid crystal polymer. When a refractive index with a polarization component parallel to the longitudinal direction of the liquid crystal polymer (an extraordinary light component) is represented by “ne”, and a refractive index with a polarization component perpendicular to the longitudinal direction of the liquid crystal polymer (an ordinary light component) is represented by “no”, the “ne” is larger than the “no”. Meanwhile, a reflective index of the filling material 19 is equal to the reflective index “no” of the liquid crystal polymer layers 17a, 17b, and 18 with the ordinary light components.

When an effective value of an alternating-current voltage applied between the transparent electrode 13c and the transparent electrode 13d and an effective value of an alternating-current voltage applied between the transparent electrode 13e and the transparent electrode 13f are within a range from 3.5 V to 5 V, the longitudinal directions of the liquid crystal polymer in the liquid crystal polymer layer 17a and the liquid crystal polymer layer 17b are almost parallel to the optical axis of the incoming light as shown in FIG. 15A. Accordingly, the reflective indexes of the liquid crystal polymer layer 17a and the liquid crystal polymer layer 17b with the incoming light become the “no”. On this occasion, the liquid crystal polymer layer 17a and the liquid crystal polymer layer 17b act as full wavelength plates that do not change the polarization direction of the incoming light. Meanwhile, when the effective value of the alternating-current voltage applied between the transparent electrode 13c and the transparent electrode 13d and the effective value of the alternating-current voltage applied between the transparent electrode 13e and the transparent electrode 13f are within a range from 0V to 1.5V, the longitudinal directions of the liquid crystal polymers in the liquid crystal polymer layer 17a and the liquid crystal polymer layer 17b are almost perpendicular to the optical axis of the incoming light as shown in FIG. 15B. Accordingly, the reflective indexes of the liquid crystal polymer layer 17a and the liquid crystal polymer layer 17b with the incoming light become the “ne” with the extraordinary light component, and become the “no” with the ordinary light component. Meanwhile, in the liquid crystal polymer layer 17a and the liquid crystal polymer layer 17b, an angle of the longitudinal direction with a direction parallel to the paper surface in a cross section perpendicular to the optical axis is 45°, and an angle of the longitudinal direction with a direction perpendicular to the paper surface in the cross section is 45°. Here, when a wavelength of the incoming light toward the liquid crystal polymer layer 17a and the liquid crystal polymer layer 17b is represented by λ, and a thickness of the liquid crystal polymer layer 17a and the liquid crystal polymer layer 17b is represented by t, a value of the thickness t is set to satisfy an expression of 2π (ne−no) t/λ=π. In addition, the polarization direction of the incoming light toward the liquid crystal polymer layer 17a and the liquid crystal polymer layer 17b is parallel or perpendicular to the paper surface. At this time, the liquid crystal polymer layer 17a and the liquid crystal polymer layer 17b act as half wavelength plates for changing the polarization direction of the incoming light by 90°.

The longitudinal direction of the liquid crystal polymer in the liquid crystal polymer layer 18 is perpendicular to the paper surface. Accordingly, in the cross-section perpendicular to the optical axis, when linear polarized light whose polarization direction is perpendicular to the paper surface is represented by TE polarized light, and linear polarized light whose polarization direction is parallel with the paper surface is represented by TM polarized light, the TE polarized light is extraordinary light with the liquid crystal polymer layer 18, and the TM polarized light is the ordinary light with the liquid crystal polymer layer 18. A cross-section shape of the diffractive grating formed on the boundary between the liquid crystal polymer layer 18 and the filling material 19 is a rectangular shape, in which a width of a liquid crystal polymer portion is equal to a width of a filling material portion. Here, when a wavelength of the incoming light toward the diffractive grating is represented by λ, a thickness of the liquid crystal polymer portion and the filling material portion in the diffractive grating is represented by t, and a phase difference generated between the liquid crystal polymer portion and the filling material portion in the diffractive grating is represented by φ, φ=2π(ne−no)t/λ is satisfied with respect to the TE polarized light and φ=0 is satisfied with respect to the TM polarized light. At this time, the transmittance of the diffraction grating is given by an expression of cos² (φ/2).

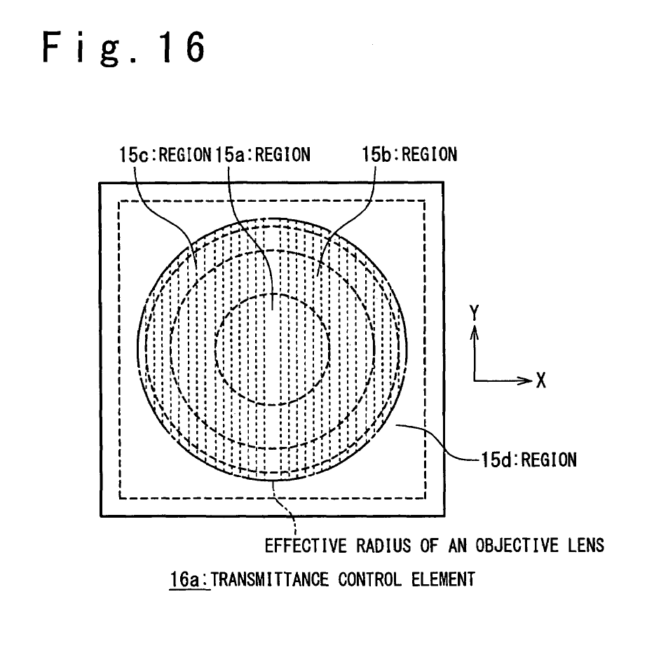

FIG. 16 is a plane view showing the transmittance control element 16a. The liquid crystal polymer layer 18 and the filling material 19 in the transmittance control element 16a are divided into four regions, which are regions 15a to 15d, by three concentric circles whose centers are the optical axis of the incoming light. In the diffractive grating, the thickness t of the liquid crystal polymer portion and the filling material portion is different between the regions 15a to 15d, t=0 nm in the region 15d, and the thicknesses t in the regions 15c, 15b, and 15a become larger in this order. Here, when the numeral aperture of the objective lens 7 is 0.65, an effective radius of the objective lens 7 becomes “3 mm×0.65=1.95 mm” as shown by a dashed line in FIG. 16. In addition, a radius of a circle on a boundary between the region 15a and the region 15b is 0.86 mm, a radius of a circle on a boundary between the region 15b and the region 15c is 1.44 mm, and a radius of a circle on a boundary between the region 15c and the region 15d is 1.81 mm. Moreover, λ=405 nm, ne−no=0.25, and values of the thicknesses t in the regions 15a, 15b, 15c, and 15d are 306 nm, 244 nm, 170 nm, and 0 nm, respectively. On this occasion, values of the phase difference φ in the regions 15a, 15b, 15c, and 15d are respectively 68.0°, 54.3°, 37.7°, and 0° regarding the TE polarization, and values of the phase difference φ in the regions 15a, 15b, 15c, and 15d are all 0° regarding the TM polarized light.

When the effective value of the alternating-current voltage applied between the transparent electrode 13c and the transparent electrode 13d and the effective value of the alternating-current voltage applied between the transparent electrode 13e and the transparent electrode 13f of the transmittance control element 16a are within a range from 3.5V to 5V, the light inputted to the transmittance control element 16a as linear polarized light whose polarization direction is in the X direction does not change the polarization direction in the liquid crystal polymer layer 17a, and is inputted to the diffractive grating formed on the boundary between the liquid crystal polymer layer 18 and the filling material 19 as the TM polarized light. This light almost entirely transmits through the diffraction grating, and is inputted to the liquid crystal polymer layer 17b as linear polarized light whose polarization direction is along the X direction. This light does not change the polarization direction in the liquid crystal polymer layer 17b, and is outputted from the transmittance control element 16a. The transmittance of the intensity distribution switching part configured by the transmittance control element 16a coincides to the transmittance of the diffractive grating, and is 1 regardless of the R that is the distance from the optical axis. On this occasion, the intensity distribution of the outputted light from the intensity distribution switching part is the same as that shown in FIG. 6. Accordingly, the rim intensity in the objective lens 7 becomes 0.55.

On the other hand, when the effective value of the alternating-current voltage applied between the transparent electrode 13c and the transparent electrode 13d and the effective value of the alternating-current voltage applied between the transparent electrode 13e and the transparent electrode 13f of the transmittance control element 16a are within a range from 0V to 1.5V, the light inputted to the transmittance control element 16a as linear polarized light whose polarization direction is in the X direction changes the polarization direction by 90° in the liquid crystal polymer layer 17a, and is inputted to the diffractive grating formed on the boundary between the liquid crystal polymer layer 18 and the filling material 19 as the TE polarized light. This light transmits through the diffractive grating at the transmittance of cos² (φ/2), and is inputted to the liquid crystal polymer layer 17b as linear polarized light whose polarization direction is along the Y direction. However, values of the phase difference φ are different from each other between the regions 15a to 15d. This light changes the polarization direction by 90° in the liquid crystal polymer layer 17b, and is outputted from the transmittance control element 16a. The transmittance of the intensity distribution switching part configured by the transmittance control element 16a coincides to the transmittance of the diffractive grating, and is shown by a solid line in FIG. 7. Specifically, the transmittance is 0.69 in a range of “0 mm<R<0.86 mm”, the transmittance is 0.79 in a range of “0.86 mm<R<1.44 mm”, the transmittance is 0.90 in a range of “1.44 mm<R<1.81 mm”, and the transmittance is 1 in a range of “1.81 mm<R<1.95 mm”. At this time, the intensity distribution of the outputted light from the intensity distribution switching part is shown by a solid line in FIG. 8. The intensity of the light passing through the center of the objective lens 7 (R=0 mm) is 0.69, and the intensity of the light passing through the rim of the objective lens 7 (R=1.95 mm) is 0.55. Accordingly, the rim intensity in the objective lens 7 becomes 0.80.

The light outputted from the transmittance control element 16a is inputted to the polarization beam splitter 5 as P-polarized light regardless of the effective value of the alternating-current voltage applied between the transparent electrode 13c and the transparent electrode 13d and the effective value of the alternating-current voltage applied between the transparent electrode 13e and the transparent electrode 13f in the transmittance control element 16a. Accordingly, this light almost entirely transmits through the polarization beam splitter 5.

In the case of recording information on the disk 8, the effective value of the alternating-current voltage applied between the transparent electrode 13c and the transparent electrode 13d and the effective value of the alternating-current voltage applied between the transparent electrode 13e and the transparent electrode 13f in the transmittance control element 16a are set to be within a range from 3.5 V to 5 V. Accordingly, the rim intensity in the objective lens 7 becomes 0.55. At this time, the diameter of the condensed spot formed on the disk 8 becomes 0.529 μm (1/e² Full width), and the efficiency of the optical system in the outward path becomes 45.0%. On the other hand, in the case of reproducing information from the disk 8, the effective value of the alternating-current voltage applied between the transparent electrode 13c and the transparent electrode 13d and the effective value of the alternating-current voltage applied between the transparent electrode 13e and the transparent electrode 13f in the transmittance control element 16a are set to be within a range from 0 V to 1.5 V. Accordingly, the rim intensity in the objective lens 7 becomes 0.80. At this time, the diameter of the condensed spot formed on the disk 8 becomes 0.518 μm (1/e² Full width), and the efficiency of the optical system in the outward path becomes 36.7%. That is, slightly increasing the diameter of the condensed spot and increasing the efficiency of the optical system in the outward path can be realized by reducing the rim intensity in the case of recording information on the disk 8, and reducing the diameter of the condensed spot and slightly reducing the efficiency of the optical system in the outward path can be realized by increasing the rime intensity in the case of reproducing information from the disk 8.

In an optical head device according to a sixth exemplary embodiment of the present invention, the transmittance control element 16a according to the fifth exemplary embodiment is replaced to a transmittance control element 16b, and the beam shaping lens 2 is deleted. By the deletion of the beam shaping lens 2, a cross-section shape of the light in the outward path becomes an ellipse shape, in which a minor axis is along the X direction and a major axis is along the Y direction. Here, the spread angle of the beam in the X direction in the semiconductor laser 1 is 8.5° (HWHM) and the spread angle of the beam in the Y direction is 20.0° (HWHM). In addition, a focal length of the collimator lens 3 is 20.0 mm, and a focal length of the objective lens 7 is 3.0 mm. At this time, when the transmittance control element 16b is not used, the rim intensity in the objective lens 7 becomes 0.30 in the X direction and becomes 0.80 in the Y direction.

A cross-section of the transmittance control element 16b is the same as that shown in FIGS. 15A and 15B. When the effective value of the alternating-current voltage applied between the transparent electrode 13c and the transparent electrode 13d and the effective value of the alternating-current voltage applied between the transparent electrode 13e and the transparent electrode 13f are within a range from 3.5V to 5V in the transmittance control element 16a, the liquid crystal polymer layer 17a and the liquid crystal polymer layer 17b act as full wavelength plates that do not change the polarization directions of incoming light. On the other hand, when the effective value of the alternating-current voltage applied between the transparent electrode 13c and the transparent electrode 13d and the effective value of the alternating-current voltage applied between the transparent electrode 13e and the transparent electrode 13f are within a range from 0V to 1.5V in the transmittance control element 16a, the liquid crystal polymer layer 17a and the liquid crystal polymer layer 17b act as half wavelength plates that change the polarization directions of incoming light by 90°. In addition, when a wavelength of incoming light toward the diffractive grating formed on the boundary between the liquid crystal polymer layer 18 and the filling material 19 is represented by λ, a thickness of the liquid crystal polymer portion and the filling material portion in the diffractive grating is represented by t, and a phase difference generated between the liquid crystal polymer portion and the filling material portion of the diffractive grating is represented by φ, φ=2π(ne−no)t/λ is satisfied with respect to the TE polarized light and φ=0 is satisfied with respect to the TM polarized light. At this time, the transmittance of the diffraction grating is given by an expression of cos² (φ/2).

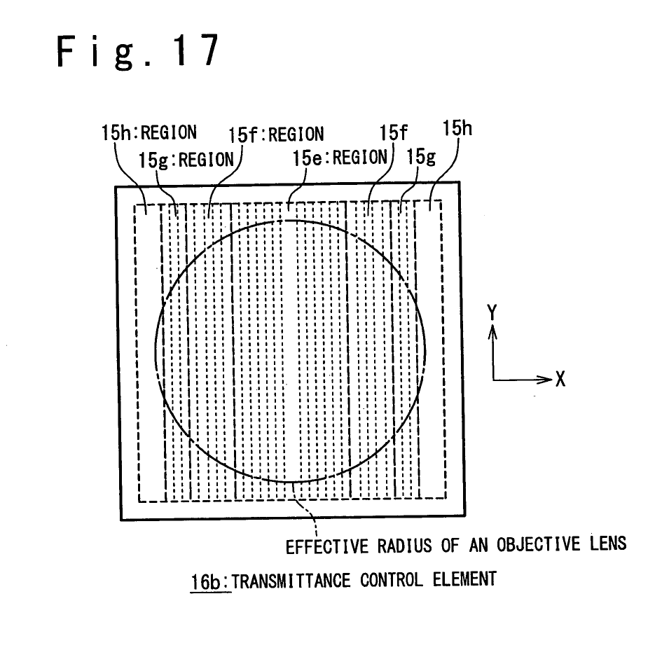

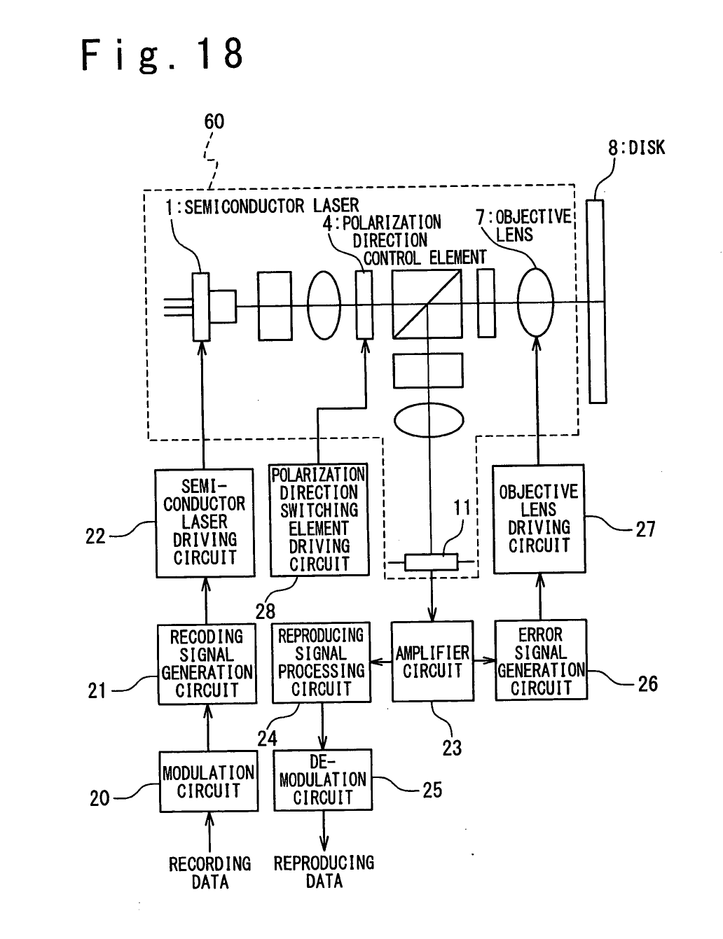

FIG. 17 is a plane view showing the transmittance control element 16b. The liquid crystal polymer layer 18 and the filling material 19, which are in the transmittance control element 16b, are divided into seven regions by six straight lines that are symmetric to the optical axis and parallel to the Y direction. Among them, the region including the optical axis is represented by region 15e, two regions positioning at both sides of the region 15e are respectively represented by regions 15f, two regions positioning on sides of the regions 15f and opposite to the region 15e are represented by regions 15g, and two regions positioning on sides of the regions 15g and opposite to the regions 15f are represented by regions 15h. The thickness t of the liquid crystal polymer portion and the filling material portion in the diffractive grating is different between the regions 15e to 15h, t=0 nm in the regions 15h, and the thicknesses t becomes larger in an order of regions 15g, 15f, and 15e.

Here, when the numeral aperture of the objective lens 7 is 0.65, the effective radius of the objective lens 7 is “3 mm×0.65=1.95 mm” as shown by a dashed line in FIG. 17. In addition, a distance from the optical axis to a straight line on a boundary between the region 15e and the region 15f is 0.97 mm, a distance from the optical axis to a straight line on a boundary between the region 15f and the region 15g is 1.53 mm, and a distance from the optical axis to a straight line on a boundary between the region 15g and the region 15h is 1.84 mm. Moreover, λ=405 nm, ne−no=0.25, values of the thicknesses t in the regions 15e, 15f, 15g, and 15h are respectively 470 nm, 362 nm, 244 nm, and 0 nm. On this occasion, values of the phase differences φ in the regions 15e, 15f, 15g, and 15h are respectively 104.5°, 80.4°, 54.3°, and 0° with respect to the TE polarized light, and values of the phase difference φ in the regions 15e, 15f, 15g, and 15h are all 0° with respect to the TM polarized light.

When the effective value of the alternating-current voltage applied between the transparent electrode 13c and the transparent electrode 13d and the effective value of the alternating-current voltage applied between the transparent electrode 13e and the transparent electrode 13f in the transmittance control element 16b are within a range from 3.5V to 5V, the light inputted to the transmittance control element 16b as linear polarized light whose polarization direction is along the X direction, is inputted to the diffractive grating formed on the boundary between the liquid crystal polymer layer 18 and the filling material 19 as the TM polarized light, without changing the polarization direction in the liquid crystal polymer layer 17a. This light almost entirely transmits through the diffraction grating, and is inputted to the liquid crystal polymer layer 17b as linear polarized light whose polarization direction is along the X direction. This light does not change the polarization direction in the liquid crystal polymer layer 17b, and is outputted from the transmittance control element 16b. The transmittance of the intensity distribution switching part configured by the transmittance control element 16b coincides to the transmittance of the diffractive grating, and is 1 regardless of X and Y which are X direction component and Y direction component in a distance from the optical axis. On this occasion, the intensity distribution of the outputted light from the intensity distribution switching part is the same as those shown in FIGS. 10A and 10B. Accordingly, the rim intensity in the objective lens 7 becomes 0.30 regarding the X direction and becomes 0.80 regarding the Y direction.

On the other hand, when the effective value of the alternating-current voltage applied between the transparent electrode 13c and the transparent electrode 13d in the transmittance control element 16a and the effective value of the alternating-current voltage applied between the transparent electrode 13e and the transparent electrode 13f are within a range from 0V to 1.5V, light, which is inputted to the transmittance control element 16b as linear polarized light whose polarization direction is along the X direction, changes the polarization direction by 90° in the liquid crystal polymer layer 17a, and is inputted to the diffractive grating formed on the boundary between the liquid crystal polymer layer 18 and the filling material 19 as the TE polarized light. This light transmits through the diffractive grating at the transmittance of cos² (φ/2), and is inputted to the liquid crystal polymer layer 17b as linear polarized light whose polarization direction is along the Y direction. Values of the phase differences φ are different from each other between the regions 15e to 15h. This light changes the polarization direction by 90° in the liquid crystal polymer layer 17b, and is outputted from the transmittance control element 16b.

The transmittance distribution of the intensity distribution switching part configured by the transmittance control element 16b coincides to the transmittance distribution of the diffractive grating, is shown by a solid line in FIG. 11A regarding the X direction, and is shown by a solid line in FIG. 11B regarding the Y direction. Specifically, the transmittance is 0.37 in a range of “0 mm<X<0.97 mm”, the transmittance is 0.58 in a range of “0.97 mm<X<1.53 mm”, the transmittance is 0.79 in a range of “1.53 mm<X<1.84 mm”, and the transmittance is 1 in a range of “1.84 mm<X<1.95 mm”. At this time, the intensity distribution of the incoming light from the intensity distribution switching part is shown by a solid line in FIG. 12A regarding the X direction, and is shown by a solid line in FIG. 12B regarding the Y direction. The intensity of the light passing through the center of the objective lens 7 (X=0 mm, Y=0 mm) is 0.37, the intensity of the light passing through the rim of the objective lens 7 in the X direction (X=1.95 mm, Y=0 mm) is 0.30, and the intensity of the light passing through the rim of the objective lens 7 in the Y direction (X=0 mm, Y=1.95 mm) is 0.30. Accordingly, the rim intensity in the objective lens 7 becomes 0.80 regarding the X direction and becomes 0.80 regarding the Y direction.

The light outputted from the transmittance control element 16b is inputted to the polarization beam splitter 5 as P-polarized light, regardless of the effective value of the alternating-current voltage applied between the transparent electrode 13c and the transparent electrode 13d and the effective value of the alternating-current voltage applied between the transparent electrode 13e and the transparent electrode 13f in the transmittance control element 16b. Accordingly, this light almost entirely transmits through the polarization beam splitter 5.

At the time of recording information on the disk 8, the effective value of the alternating-current voltage applied between the transparent electrode 13c and the transparent electrode 13d and the effective value of the alternating-current voltage applied between the transparent electrode 13e and the transparent electrode 13f in the transmittance control element 16b are set to be within a range from 3.5 V to 5 V. As the result, the rim intensity in the objective lens 7 becomes 0.30 regarding the X direction and becomes 0.80 regarding the Y direction. At this time, the diameter of the condensed spot formed on the disk 8 becomes 0.557 μm (1/e² Full width) regarding the X direction and becomes 0.508 μm (1/e² Full width) regarding the Y direction, and an efficiency of the optical system in the outward path becomes 37.6%. On the other hand, at the time of reproducing information from the disk 8, the effective value of the alternating-current voltage applied between the transparent electrode 13c and the transparent electrode 13d and the effective value of the alternating-current voltage applied between the transparent electrode 13e and the transparent electrode 13f in the transmittance control element 16b are set to be within a range from 0 V to 1.5 V. Accordingly, the rim intensity in the objective lens 7 becomes 0.80 regarding the X direction and becomes 0.80 regarding the Y direction. At this time, the diameter of the condensed spot formed on the disk 8 becomes 0.515 μm (1/e² Full width) regarding the X direction and becomes 0.520 m (1/e² Full width) regarding the Y direction, and the efficiency of the optical system in the outward path becomes 16.9%. That is, slightly increasing the diameter of the condensed spot regarding the X direction and increasing the efficiency of the optical system in the outward path can be realized by reducing the rim intensity regarding the X direction in the case of recording information on the disk 8, and reducing the diameter of the condensed spot regarding the X direction and slightly reducing the efficiency of the optical system in the outward path can by realized by increasing the rim intensity regarding the X direction.

In the transmittance control element 16a according to the fifth exemplary embodiment and the transmittance control element 16b according to the sixth exemplary embodiment, the transmittance control element switches the polarization direction of the light inputted to the diffractive grating, the phase difference generated between the liquid crystal polymer portion and the filling material is switched in the diffractive grating, the transmittance of the diffractive grating is switched. On the other hand, an exemplary embodiment can be also realized, in which a liquid crystal polymer layer and a filling material divided into a plurality of regions are employed as the liquid crystal polymer layer and a filling material that constitute the diffractive grating, the transparent electrodes including a single region for sandwiching them is employed, the phase difference generated between the liquid crystal polymer portion and the filling material is switched in the diffractive grating by switching the effective value of the alternating-current voltage applied to the transparent electrodes, and the transmittance in the diffractive grating is switched. In this exemplary embodiment, at the time of reproducing information from the disk, the phase difference generated between the liquid crystal polymer portion and the filling material is changed in the diffractive grating, by varying the thickness of the liquid crystal polymer portion and the filling material according to the respective regions of the liquid crystal polymer portion and the filling material.

Specifically, in the case of recording information on the disk, the effective value of the alternating-current voltage applied to the transparent electrode is set to be within a range from 3.5V to 5V. In this case, the longitudinal direction of the liquid crystal polymer is almost parallel to the optical axis of the incoming light. At this time, the phase difference generated between the liquid crystal polymer portion and the filling material of the diffractive grating becomes 0, and the incoming toward the diffractive grating almost entirely transmits through the diffractive grating. On the other hand, at the time of reproducing information from the disk, the effective value of the alternating-current voltage applied to the transparent electrode is set to be within a range from 0V to 1.5V. In this case, the longitudinal direction of the liquid crystal polymer is almost perpendicular to the optical axis of the incoming light and is parallel with the polarization direction of the incoming light. At this time, the phase difference generated between the liquid crystal polymer portion and the filling material of the diffractive grating varies based on the thickness of the liquid crystal polymer portion and the filling material. Accordingly, the incoming light toward the diffractive grating transmits through the diffracting grating at a transmittance based on the thickness of the liquid crystal polymer portion and the filling material. However, since the thicknesses of the liquid crystal polymer portion and the filling material are different from each other between a plurality of regions of the liquid crystal polymer portion and the filling material, the phase difference generated between the liquid crystal polymer portion and the filling material of the diffractive grating and the transmittance of the diffractive grating are different from each other between a plurality of the regions of the liquid crystal polymer portion and the filling material.

In addition, an exemplary embodiment can be realized, in which a liquid crystal polymer layer and a filling material which include a single region are employed as the liquid crystal polymer and the filling material that constitute the diffractive grating, transparent electrodes divided into a plurality of regions for sandwiching them are employed, the phase difference generated between the liquid crystal polymer portion and the filling material is switched in the diffractive grating by switching the effective value of the alternating-current voltage applied to the transparent electrodes, and the transmittance in the diffractive grating is switched. In this exemplary embodiment, at the time of reproducing information from the disk, the phase difference generated between the liquid crystal polymer portion and the filling material in the diffractive grating is varied by varying the effective value of the alternating-current voltage applied to the respective regions of the transparent electrode.

Specifically, at the time of recording information on the disk, the effective value of the alternating-current voltage applied to the transparent electrode is set to be within a range from 3.5V to 5V. In this case, the longitudinal direction of the liquid crystal polymer is almost parallel with the optical axis of the incoming light. At this time, the phase difference generated between the liquid crystal polymer portion and the filling material of the diffractive grating becomes 0, and the incoming light toward the diffractive grating almost entirely transmits through the diffractive grating. On the other hand, at the time of reproducing information from the disk, the effective value of the alternating-current voltage applied to the transparent electrode is set to be within a range from 1.5V to 3.5V. At this time, in a surface which includes the optical axis of the incoming light and is parallel to the polarization direction of the incoming light, an angle of the longitudinal direction of the liquid crystal polymer with a direction perpendicular to the optical axis of the incoming light becomes a predetermined angle. This angle changes almost-linearly with the effective value of the alternating-current voltage. At this time, the phase difference generated between the liquid crystal polymer portion and the filling material in the diffractive grating is varied based on the effective value of the alternating-current voltage. Accordingly, the incoming light inputted to the diffractive grating transmits through the diffracting grating at a transmittance based on the effective value of the alternating-current voltage. However, since the effective value of the alternating-current voltage is different from each other between a plurality of regions in the transparent electrode, the phase difference generated between the liquid crystal polymer portion and the filling material in the diffractive grating and the transmittance of the diffractive grating are different between a plurality of the regions of the transparent electrode.

FIG. 18 shows a configuration of an optical information recording/reproducing device according to a seventh exemplary embodiment of the present invention. The optical information recording/reproducing device includes the optical head device 60, a modulation circuit 20, a recording signal generation circuit 21, a semiconductor laser driving circuit 22, an amplifier circuit 23, a reproducing signal processing circuit 24, a demodulation circuit 25, an error signal generation circuit 26, an objective lens driving circuit 27, and a polarization direction switching element driving circuit 28. The optical head device 60 in the present exemplary embodiment is the optical head device explained in the first exemplary embodiment. These circuits are controlled by a controller not shown in the drawings.

When data is recorded on the disk 8, the modulation circuit 20 modulates data to be recorded on the disk 8 in accordance with a modulation rule. The recording signal generation circuit 21 generates a recording signal for driving the semiconductor laser 1 in accordance with a recording strategy, based on the signal modulated by the modulation circuit 20. On the basis of the recording signal generated by the recording signal generation circuit 21, the semiconductor laser driving circuit 22 supplies an electric current based on the recording signal to the semiconductor laser 1, and drives the semiconductor laser 1. On the other hand, when data is reproduced from the disk 8, the semiconductor laser driving circuit 22 supplies a constant current to the semiconductor laser 1 so that a power of outputted light from the semiconductor laser 1 becomes constant, and the semiconductor laser 1 is driven.

The amplifier circuit 23 amplifies a voltage signal outputted from each light-receiving part of the light detector 11. When data is reproduced from the disk 8, the reproducing signal processing circuit 24 executes generation of a reproducing signal that is a mark/space signal recorded on the disk 8, waveform equalization, and binarization based on the voltage signal amplified by the amplifier circuit 23. The demodulation circuit 25 demodulates the signal binarized by the reproducing signal processing circuit 24 in accordance with a demodulation rule. Based on the voltage signal amplified by the amplifier circuit 23, the error signal generation circuit 26 generates a focus error signal and a track error signal for driving the objective lens 7. The objective lens driving circuit 27 supplies an electric current based on the focus error signal and the track error signal into an actuator not shown in the drawings, and drives the objective lens 7 based on the focus error signal and the track error signal generated by the error signal generation circuit 26.

Moreover, the optical head device 60 is driven to a radius direction of the disk 8 by a positioner not shown in the drawings, and the disk 8 is driven to be rotated by a spindle not shown in the drawings. The polarization direction control element driving circuit 28 applies an alternating-current voltage between the transparent electrode 13a and the transparent electrode 13b in the polarization direction control element 4a, and drives the polarization direction control element 4a. In the polarization direction control element driving circuit 28, the effective value of an alternating-current voltage is set to be within a range from 3.5V to 5V at the time of recording data on the disk 8, and the effective value of the alternating-current voltage is set to be within a range from 0V to 1.5V at the time of reproducing data from the disk 8. In such optical information recording/reproducing device, the optical head device 60 may be the optical head device explained in the second to fourth exemplary embodiments.

An optical information recording/reproducing device according to an eighth exemplary embodiment of the present invention includes: the optical head device explained in the fifth exemplary embodiment as the optical head device 60 in the optical information recording/reproducing device explained in the seventh exemplary embodiment; and a transmittance control element driving circuit in place of the polarization direction control element driving circuit 28. The transmittance control element driving circuit drives the transmittance control element, by applying an alternating-current voltage between the transparent electrode 13c and the transparent electrode 13d and applying an alternating-current voltage between the transparent electrode 13e and the transparent electrode 13f. In the transmittance control element driving circuit, the effective value of the alternating-current voltage is set to be within a range from 3.5V to 5V at the time of recording, and the effective value of the alternating-current voltage is set to be within a range from 0V to 1.5V at the time of reproducing. In such optical information recording/reproducing device, the optical head device 60 may be the optical head device explained in the sixth exemplary embodiment.

As described above, the present invention has been explained, referring to the exemplary embodiments, however, the present invention is not limited to the above-described exemplary embodiments. Various modifications that can be understood by a person skilled in the art can be carried out on the configuration and the details of the present invention within a scope of the present invention.

1. An optical head device comprising:
an objective lens configured to collect outward path light outputted from a light source on an optical recording medium;
a light detector configured to receive return path light collected by said objective lens and reflected by said optical recording medium;
a light splitting unit configured to split said outward path light and said return path light; and
an intensity distribution switching unit, which is provided in a path of said outward path light and is configured to switch intensity of incoming light with outputted light based on a position in a cross-section perpendicular to an optical axis of said outward path light to switch an intensity distribution of said outward path light without changing a phase distribution of said outward path light,
wherein said intensity distribution switching unit includes:
a wavelength plate whose function is able to be switched between a full wavelength plate which does not change a polarization direction of outputted light with incoming light and a ½ wavelength plate which changes a polarization direction of outputted light with incoming light based on a position in said cross-section perpendicular to said optical axis; and
a polarization beam splitter.

2. The optical head device according to claim 1, wherein said intensity distribution switching unit is configured to change rim intensity to switch said intensity distribution without a lens function for changing a beam diameter of said outward path light, and said rim intensity is represented by a ratio of intensity of light passing through a rim of said objective lens to intensity of light passing through a center of said objective lens.

3. The optical head device according to claim 1, wherein said intensity distribution switching unit is configured to switch said intensity distribution between a first intensity distribution corresponding to a case of recording information to said optical recording medium and a second intensity distribution corresponding to a case of reproducing information from said optical recording medium.

4.-5. (canceled)

6. The optical head device according to claim 1, wherein said intensity distribution switching unit includes:
a pair of a transparent electrode, in which each electrode is constituted by a single region; and
a liquid crystal polymer layer, which is sandwiched by said pair of said transparent electrode and includes liquid crystal polymer changing a orientation direction based on a voltage applied to said pair of said transparent electrode.

7. An optical information recording/reproducing device comprising:
the optical head device according to claim 1; and
a driving circuit configured to drive said intensity distribution switching unit to switch said intensity distribution.

8.-11. (canceled)
